(19) United States
(12) Patent Application Publication
(10) Pub. No.: US 2026/0080561 A1
(43) Pub. Date: Mar. 19, 2026

(54) CONTROL METHOD AND CONTROL APPARATUS OF BROADCAST MONITORING SYSTEM, COMPUTER DEVICE AND COMPUTER STORAGE MEDIUM

(71) Applicants: Beijing BOE Technology Development Co., Ltd., Beijing (CN); BOE Technology Group Co., Ltd., Beijing (CN)

(72) Inventors: Tingting WANG, Beijing (CN); Guangwei HUANG, Beijing (CN)

(21) Appl. No.: 18/995,998

(22) PCT Filed: Apr. 17, 2024
(86) PCT No.: PCT/CN2024/088351

§ 371 Date: Jan. 17, 2025

(30) Foreign Application Priority Data
May 31, 2023 (CN) 202310636620.3

(51) Int. Cl. G06T 7/73; G06F 3/01; G06N 3/045; G06N 3/082; G06V 10/25; G06V 20/70; G06V 40/16

(52) U.S. Cl. CPC G06T 7/73; G06F 3/013; G06N 3/045; G06N 3/082; G06V 10/25; G06V 20/70; G06V 40/161

(57) ABSTRACT

The present disclosure provides a control method of a broadcast monitoring system, a control apparatus of a broadcast monitoring system, a computer device, and a computer storage medium, and belongs to the field of image recognition and terminal broadcast monitoring. The control method of a broadcast monitoring system includes: obtaining a detected image; performing gaze recognition on the detected image through a pre-trained target neural network model, to obtain a recognition result of the detected image; and sending the recognition result to a terminal, so that the terminal determines a display state based on at least the recognition result.

### TECHNICAL FIELD

The present disclosure belongs to the field of image recognition and terminal broadcast monitoring, and particularly relates to a control method of a broadcast monitoring system, a control apparatus of a broadcast monitoring system, a computer device, and a computer storage medium.

### BACKGROUND

With rapid development of information technology, modern electronic devices are also rapidly developed towards intellectualization, light weight and portability. For an intelligent terminal, a monitoring picture is displayed on a display screen for a long time, resulting in a large power consumption of the system and service life of the system being influenced. Therefore, how to realize low-power operation is an urgent technical problem to be solved in the field of broadcast monitoring.

### SUMMARY

The present disclosure aims to solve at least one technical problem in the prior art and provides a control method of a broadcast monitoring system, a control apparatus of a broadcast monitoring system, a computer device, and a computer storage medium.

In a first aspect, a technical solution adopted to solve the technical problem of the present disclosure is a control method of a broadcast monitoring system, including:
acquiring a detected image;
performing gaze recognition on the detected image through a target neural network model which is trained in advance, to obtain a recognition result of the detected image; and
sending the recognition result to a terminal, so that the terminal determines a display state based on at least the recognition result.

In some embodiments, a target neural network model is obtained by training through the following steps:
training a to-be-trained teacher network learning model according to an acquired training data set, to obtain a trained teacher network learning model; and
training a to-be-trained student network learning model by a knowledge distillation training method, according to the training data set and the trained teacher network learning model, to obtain a trained student network learning model as the target neural network model.

In some embodiments, the training data set includes a plurality of training images labeled with sample labels;
the training a to-be-trained student network learning model by a knowledge distillation training method, according to the training data set and the trained teacher network learning model, to obtain a trained student network learning model as the target neural network model, includes:
inputting a training image of the plurality of training images into the trained teacher network learning model, to obtain a first output result of the trained teacher network learning model;
inputting the training image into the to-be-trained student network learning model, to obtain a second output result of the to-be-trained student network learning model;
determining a first loss function, according to the first output result and the second output result;
determining a second loss function, according to the second output result and a sample label of the training image;
obtaining a weighted loss function, according to the first loss function and the second loss function; and
adjusting parameters of the to-be-trained student network learning model according to the weighted loss function, until the weighted loss function is converged, to obtain the trained student network learning model as the target neural network model.

In some embodiments, the training data set is determined through the following steps:
acquiring an original data set, where the original data set includes a plurality of initial sample images;
performing face recognition on the initial sample image, in responset to a face existing, determining a first reference box containing the face, and determining key point information of the face;
determining pose information of the face, according to the key point information;
updating the first reference box, according to the pose information and a ratio of the first reference box to the initial sample image, to obtain a second reference box; and
marking a partial sample image, which is a part of the initial sample image in the second reference box, with a sample label, according to the first reference box and the second reference box, and taking the partial sample image marked with the sample label as a training image,
wherein the sample labels include a first class label for representing gaze, and a second class label and a third class label for representing non-gaze;
the first class label indicates that a pitch angle of the face is less than or equal to a first set value, a yaw angle of the face is less than or equal to a second set value, or a roll angle of the face is less than or equal to a third set value, and a ratio of the second reference box in the training image to the training image is greater than or equal to a first preset threshold value;
the second class label indicates that the pitch angle of the face is greater than the first set value, the yaw angle of the face is greater than the second set value, or the roll angle of the face is greater than the third set value, and the ratio of the second reference box in the training image to the training image is greater than or equal to the first preset threshold value; and
the third class label represents that the ratio of the second reference box in the training image to the training image is less than the first preset threshold value and greater than a second preset threshold value.

In some embodiments, the pose information includes at least the pitch angle, the yaw angle and the roll angle of the face; and
the updating the first reference box, according to the pose information and a ratio of the first reference box to the initial sample image, to obtain a second reference box, includes:
moving a specific coordinate point in the first reference box in accordance with a first set range, according to the position information of the first reference box, to obtain the second reference box, under the conditions that the ratio of the first reference box to the initial sample image is greater than or equal to the first preset threshold value, the pitch angle of the face is less than or equal to the first set value, the yaw angle of the face is less than or equal to the second set value, and the roll angle of the face is less than or equal to the third set value.

In some embodiments, the marking a partial sample image, which is a part of the initial sample image in the second reference box, with a sample label, according to the first reference box and the second reference box, and taking the partial sample image marked with the sample label as a training image, includes:
determining an overlapping area between the second reference box and the first reference box, according to the position information of the second reference box and the position information of the first reference box;
generating a first preset range according to a first preset probability, generating a second preset range according to a second preset probability, generating a third preset range according to a third preset probability, and generating a fourth preset range according to a fourth preset probability, under the condition that a first ratio of the overlapping area to an area of the second reference box is greater than or equal to a third preset threshold value; where the first preset probability is greater than the second preset probability, the second preset probability is greater than the third preset probability, and the third preset probability is greater than or equal to the fourth preset probability; and a sum of the first preset probability, the second preset probability, the third preset probability and the fourth preset probability is 1;
when the first ratio is within the first preset range, determining and marking the partial sample image of the initial sample image in the second reference box, with the first class label, such that a second ratio of a number of training images with the first ratio within the first preset range and marked with the first class label to a total number of all the training images marked with the first class label in the training data set is the first preset probability;
when the first ratio is within the second preset range, determining and marking the partial sample image of the initial sample image in the second reference box, with the first class label, such that a second ratio of a number of training images with the first ratio within the second preset range and marked with the first class label to a total number of all the training images marked with the first class label in the training data set is the second preset probability;
when the first ratio is within the third preset range, determining and marking the partial sample image of the initial sample image in the second reference box, with the first class label, such that a second ratio of a number of training images with the first ratio within the third preset range and marked with the first class label to a total number of all the training images marked with the first class label in the training data set is the third preset probability; and
when the first ratio is within the fourth preset range, determining and marking the partial sample image of the initial sample image in the second reference box, with the first class label, such that a second ratio of a number of training images with the first ratio within the fourth preset range and marked with the first class label to a total number of all the training images marked with the first class label in the training data set is the fourth preset probability;
wherein data in the first preset range are less than data in the second preset range, the data in the second preset range are less than data in the third preset range, and the data in the third preset range are less than data in the fourth preset range.

In some embodiments, the pose information includes at least the pitch angle, the yaw angle and the roll angle of the face; and
the updating the first reference box, according to the pose information and a ratio of the first reference box to the initial sample image, to obtain a second reference box, includes:
moving a specific coordinate point in the first reference box in accordance with a second set range, according to the position information of the first reference box, to obtain the second reference box, under the conditions that the ratio of the first reference box to the initial sample image is greater than or equal to the first preset threshold value, the pitch angle of the face is greater than the first set value, the yaw angle of the face is greater than the second set value, and the roll angle of the face is greater than the third set value.

In some embodiments, the marking a partial sample image, which is a part of the initial sample image in the second reference box, with a sample label, according to the first reference box and the second reference box, and taking the partial sample image marked with the sample label as a training image, includes:
determining an overlapping area between the second reference box and the first reference box, according to the position information of the second reference box and the position information of the first reference box;
generating a first preset range according to a first preset probability, generating a second preset range according to a second preset probability, generating a third preset range according to the third preset probability, and generating a fourth preset range according to a fourth preset probability, under the condition that a third ratio of the overlapping area to an area of the second reference box is greater than or equal to a third preset threshold value; where the first preset probability is greater than the second preset probability, the second preset probability is greater than the third preset probability, and the third preset probability is greater than or equal to the fourth preset probability; and a sum of the first preset probability, the second preset probability, the third preset probability and the fourth preset probability is 1;
when the third ratio is within the first preset range, determining and marking the partial sample image of the initial sample image in the second reference box, with the second class label, such that a fourth ratio of a number of training images with the third ratio within the first preset range and marked with the second class label to a total number of all the training images marked with the second class label in the training data set is the first preset probability;
when the third ratio is within the second preset range, determining and marking the partial sample image of the initial sample image in the second reference box, with the second class label, such that a fourth ratio of a number of training images with the third ratio within the second preset range and marked with the second class label to a total number of all the training images marked with the second class label in the training data set is the second preset probability;
when the third ratio is within the third preset range, determining and marking the partial sample image of the initial sample image in the second reference box, with the second class label, such that a fourth ratio of a number of training images with the third ratio within the third preset range and marked with the second class label to a total number of all the training images marked with the second class label in the training data set is the third preset probability; and
when the third ratio is within the fourth preset range, determining and marking the partial sample image of the initial sample image in the second reference box, with the second class label, such that a fourth ratio of a number of training images with the third ratio within the fourth preset range and marked with the second class label to a total number of all the training images marked with the second class label in the training data set is the fourth preset probability;
wherein data in the first preset range are less than data in the second preset range, the data in the second preset range are less than data in the third preset range, and the data in the third preset range are less than data in the fourth preset range.

In some embodiments, the pose information includes at least the pitch angle, the yaw angle and the roll angle of the face;
the updating the first reference box, according to the pose information and a ratio of the first reference box to the initial sample image, to obtain a second reference box, includes:
moving a specific coordinate point in the first reference box in accordance with a third set range, according to the position information of the first reference box, to obtain the second reference box, under the condition that the ratio of the first reference box to the initial sample image is less than the first preset threshold value and greater than the second preset threshold value; where the first preset threshold value is greater than the second preset threshold value.

In some embodiments, the marking a partial sample image, which is a part of the initial sample image in the second reference box, with a sample label, according to the first reference box and the second reference box, and taking the partial sample image marked with the sample label as a training image, includes:
determining an overlapping area between the second reference box and the first reference box, according to the position information of the second reference box and the position information of the first reference box;
generating a fifth preset range according to a fifth preset probability, generating a sixth preset range according to a sixth preset probability, and generating a seventh preset range according to a seventh preset probability, under the condition that a fifth ratio of the overlapping area to an area of the second reference box is less than a third preset threshold value; where the fifth preset probability is greater than the sixth preset probability, and the sixth preset probability is greater than the seventh preset probability; and a sum of the fifth preset probability, the sixth preset probability and the seventh preset probability is 1;
when the fifth ratio is within the fifth preset range, determining and marking the partial sample image of the initial sample image in the second reference box, with the third class label, such that a sixth ratio of a number of training images with the third ratio within the fifth preset range and marked with the third class label to a total number of all the training images marked with the third class label in the training data set is the fifth preset probability;
when the fifth ratio is within the sixth preset range, determining and marking the partial sample image of the initial sample image in the second reference box, with the third class label, such that a sixth ratio of a number of training images with the sixth ratio within the sixth preset range and marked with the third class label to a total number of all the training images marked with the third class label in the training data set is the sixth preset probability; and
when the fifth ratio is within the seventh preset range, determining and marking the partial sample image of the initial sample image in the second reference box, with the third class label, such that a sixth ratio of a number of training images with the sixth ratio within the seventh preset range and marked with the third class label to a total number of all the training images marked with the third class label in the training data set is the seventh preset probability;
wherein data in the seventh preset range is less than data in the sixth preset range, and the data in the sixth preset range is less than data in the fifth preset range.

In some embodiments, the sample labels further include a fourth class label for representing non-gaze;
in a step of acquiring the training data set, under the condition that the face recognition performed on the initial sample image determines that no face exists, the method further includes:
marking the initial sample image with a fourth class label, and taking the initial sample image marked with the fourth class label as a training image.

In some embodiments, the sample labels further include a fourth class label for representing non-gaze; and
after the face recognition is performed on the initial sample image to determine that a face exists, and a first reference box containing the face is determined, the method further includes:
determining a target central point in the initial sample image in accordance with a fourth set range, according to a size of the initial sample image, and determining a third reference box with the target central point as a center; and
the third reference box is not overlapped with any first reference box in the initial sample image, marking a partial sample image, which is a part of the initial sample image in the third reference box, with a fourth class label, and taking the partial sample image marked with the fourth class label as a training image.

In a second aspect, an embodiment of the present disclosure further provides a broadcast monitoring system, where the broadcast monitoring system includes a detection apparatus and a terminal; and the control method includes:
by the detection apparatus, acquiring a detected image, and performing gaze recognition on the detected image through a pre-trained target neural network model, to obtain a recognition result of the detected image; and sending the recognition result to the terminal; and
determining, by the terminal, a display state based on the recognition result.

In some embodiments, the terminal includes a display module and a main control module; and
the determining, by the terminal, a display state based on the recognition result, includes:
sending, by the main control module, an awakening request to the display module under the condition that the recognition result indicates that an object gazes; sending, by the main control module, a sleep request to the display module under the conditions that the recognition result indicates that no object gazes and it is longer than a preset duration from the latest awakening time of the display module to the current system time; and
determining, by the display module, that the display state is normal display, in response to the awakening request; and determining, by the display module, that the display state is sleep, in response to the sleep request.

In a third aspect, an embodiment of the present disclosure further provides a detection apparatus configured to acquire a detected image, and perform gaze recognition on the detected image through a pre-trained target neural network model, to obtain a recognition result of the detected image; and send the recognition result to a terminal, so that the terminal determines a display state based on at least the recognition result.

In a fourth aspect, an embodiment of the present disclosure further provides a control apparatus of a broadcast monitoring system, including a detection apparatus and a terminal;
wherein the detection apparatus is configured to acquire a detected image, and perform gaze recognition on the detected image through a pre-trained target neural network model, to obtain a recognition result of the detected image; and send the recognition result to a terminal; and
the terminal is configured to determine a display state based on the recognition result.

In a fifth aspect, an embodiment of the present disclosure further provides a computer device, including a processor, a memory and a bus, where the memory stores machine-readable instructions executable by the processor, the processor and the memory communicate with each other through the bus, when the computer device is running, and the machine-readable instructions, when executed by a processor, cause the processor to perform steps of the control method of a broadcast monitoring system according to any one in the first aspect, and/or steps of the control method of a broadcast monitoring system according to any one in the second aspect.

In a sixth aspect, an embodiment of the present disclosure further provides a non-transitory computer readable storage medium storing thereon a computer program which, when being executed by a processor, performs steps of the control method of a broadcast monitoring system according to any one in the first aspect, and/or steps of the control method of a broadcast monitoring system according to any one in the second aspect.

### BRIEF DESCRIPTION OF DRAWINGS

FIG. 1 is a flowchart illustrating a control method of a broadcast monitoring system according to an embodiment of the present disclosure;

FIG. 2 is a schematic diagram illustrating a network architecture of an exemplary target neural network model according to an embodiment of the present disclosure;

FIG. 3 is a flowchart illustrating how to train a target neural network model according to an embodiment of the present disclosure;

FIG. 4 is a schematic diagram illustrating a network architecture of exemplary knowledge distillation according to an embodiment of the present disclosure;

FIG. 5 is a flowchart illustrating how to generate a training data set according to an embodiment of the present disclosure;

FIG. 6 is a schematic diagram illustrating exemplary summarized target key points on a face according to an embodiment of the present disclosure;

FIG. 7 is a schematic diagram illustrating exemplary different face poses according to an embodiment of the present disclosure;

FIG. 8a is a flowchart illustrating operation of an exemplary terminal according to an embodiment of the present disclosure;

FIG. 8b is a flowchart illustrating operation of an exemplary detection apparatus according to an embodiment of the present disclosure;

FIG. 9 is a schematic diagram illustrating a detection apparatus according to an embodiment of the present disclosure;

FIG. 10 is a schematic diagram illustrating a control apparatus of a broadcast monitoring system according to an embodiment of the present disclosure; and

FIG. 11 is a schematic diagram illustrating a structure of a computer device according to an embodiment of the present disclosure.

### DETAIL DESCRIPTION OF EMBODIMENTS

In order to make the objects, technical solutions and advantages of the embodiments of the present disclosure more apparent, the technical solutions of the embodiments of the present disclosure will be clearly and completely described below with reference to the drawings of the embodiments of the present disclosure. Obviously, the described embodiments are some, but not all, embodiments of the present disclosure. The components of the embodiments of the present disclosure, described and illustrated in the drawings herein, generally could be arranged and designed in a wide variety of different configurations. Thus, the following detailed description of the embodiments of the present disclosure, provided in the accompanying drawings, is not intended to limit the protection scope of the present disclosure, but merely represents selected embodiments of the present disclosure. All other embodiments, which can be derived by one of ordinary skill in the art from the described embodiments of the present disclosure without creative efforts, are within the protection scope of the present disclosure.

Unless defined otherwise, technical or scientific terms used herein shall have the ordinary meaning as understood by one of ordinary skill in the art to which the present disclosure belongs. The use of “first”, “second”, and the like in the present disclosure is not intended to indicate any order, quantity, or importance, but rather serves to distinguish one element from another. Also, the term “a”, “an”, “the” or the like does not denote a limitation of quantity, but rather denotes the presence of at least one. The word “comprising/including”, “comprises/includes”, or the like means that the element or item preceding the word includes the element or item listed after the word and its equivalent, but does not exclude other elements or items.

Reference to “a plurality of” or “a number of” in the present disclosure means two or more. “And/or” describes an association relationship between associated objects, and indicates that three relationships may exist. For example, A and/or B may indicate: A exists alone, A and B exist simultaneously, or B exists alone. The character “/” generally indicates that the associated objects before and after the character “/” are in an “or” relationship.

In the related art, with the intensive research and popularization of artificial intelligence algorithms represented by deep learning and neural networks, intelligent electronic devices and related application scenes are widely available, such as face recognition, voice recognition, smart home, security monitoring, unmanned driving, and the like. However, limited to the classical Von Neumann computing architecture, data storage and data processing are separated, the computing and storage functions are completed by a central processing unit and a memory, respectively, and a performance difference between the central processing unit and the memory forms a “memory wall”, so that a large amount of energy is consumed in frequent transmission between the computing core and the memory. However, current In-Memory Computing (IMC) design can solve this problem. IMC refers to combining memory and computation more closely than in traditional computer architectures, thereby reducing the overhead associated with memory access and solving the “memory wall” problem. The three major factors of the artificial intelligence are computing power, data and an algorithm, and IMC has the characteristics of large computing power, low power consumption and low time delay, and therefore IMC can play a great role in the future of the artificial intelligence. The current general storage and computing methods include Flash Memory (Flash) and Static Random Access Memory (SRAM). Generally, many national standards or international standards associated with intelligent terminal products have certain requirements on standby power consumption, an intelligent awakening function is designed in the products, and standby awakening for 24 hours is supported through voice detection, personnel detection and other manners, so that it is necessary to ensure lower standby power consumption of the whole detection system to meet the corresponding energy efficiency standard.

In view of this, an embodiment of the present disclosure provides a control method of a broadcast monitoring system, which substantially obviates one or more of the problems due to limitations and disadvantages of the related art. Specifically, the control method in the embodiment of the present disclosure includes: acquiring a detected image; performing gaze recognition on the detected image through a pre-trained target neural network model, to obtain a recognition result of the detected image; and sending the recognition result to a terminal, so that the terminal determines a display state based on at least the recognition result. That is, the display state of the terminal is controlled by the gaze recognition result with high accuracy. For example, if nobody stares at the screen for a long time, the terminal automatically enters a sleep state, so that the power consumption of the system is saved; during the sleep state, if the recognition result indicates that a person staring at the screen emerges, the system can be automatically started, and normal display of the screen is recovered. The present disclosure is applied to an intelligent awakening scene in a gaze environment (such as an environment where a person gazes at a display screen), saves system power consumption, and simultaneously improves the recognition precision of the person staring at the screen by combining with a neural network gaze recognition technology, so that the timing for the terminal to enter sleeping or be actively awakened can be more accurately controlled.

For convenience of understanding, firstly, a detailed description is given to a control method of a broadcast monitoring system according to an embodiment of the present disclosure. An execution subject of the control method of a broadcast monitoring system may be a detection apparatus with certain computing capability, which detection apparatus may be, for example, an IMC chip integrated with Flash or SRAM, where the response speed is faster, and the power consumption of the broadcast monitoring system is reduced. The detection apparatus may be a part of a broadcast monitoring system.

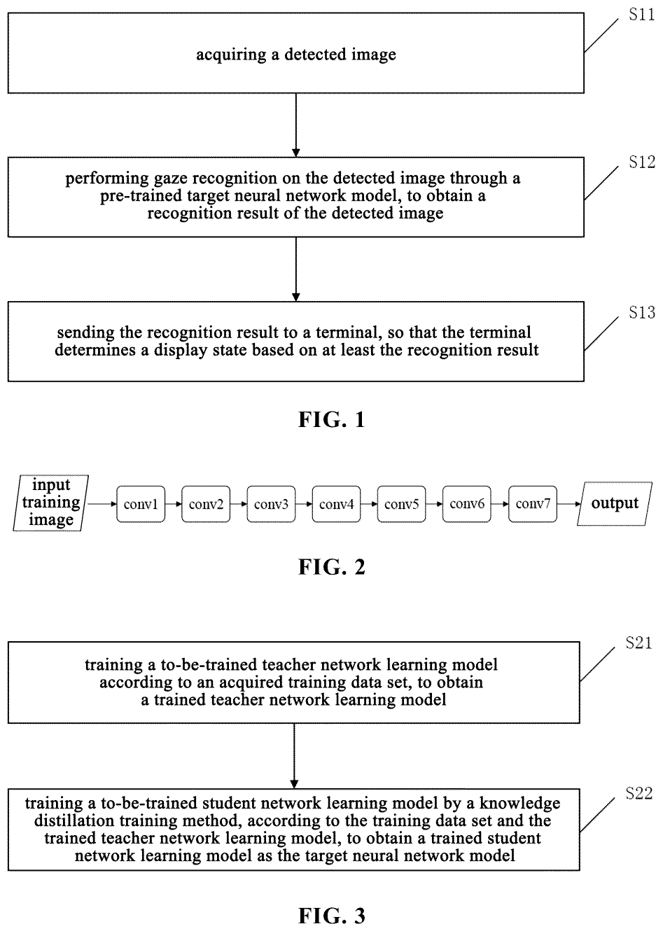

FIG. 1 is a flowchart illustrating a control method of a broadcast monitoring system according to an embodiment of the present disclosure. As shown in FIG. 1, the control method includes steps S11 to S13.

Step S11, acquiring a detected image.

In this step, the detected image is an image captured by a capturing device, which image is prepared to detect whether or not a person gazes at the screen. The detected image may be an image captured by the capturing device in real time.

The capturing device may be, for example, a device having a picture capturing function such as a camera. For example, the capturing device may be a mobile phone, a vehicle-mounted terminal, a smart home device, a security monitor, or the like.

Step S12, performing gaze recognition on the detected image through a pre-trained target neural network model, to obtain a recognition result of the detected image.

Specifically, the detected image may be input into the pre-trained target neural network model, and feature extraction and analysis may be performed on the detected image to determine whether a person gazes at the screen. The target neural network model may employ a lightweight classification model, and the recognition result may be that a person gazes at the screen or nobody gazes at the screen. Here, the screen may be, for example, a terminal display screen, or alternatively may be an image capturing device such as a camera.

In this step, the lightweight target neural network model is designed and transferred to an IMC chip, and an IMC manner with low-power-consumption is adopted to assist the target neural network in inference, so that the awakening service of the intelligent terminal is completed, the power consumption is reduced, and the response speed is high.

Step S13, sending the recognition result to a terminal, so that the terminal determines a display state based on at least the recognition result.

Specifically, the recognition result is sent to the terminal, and a main control module in the terminal may determine the display state of the terminal according to an indication of the recognition result. A display screen in the terminal may determine whether to display a picture normally or to enter sleeping in response to the currently determined display state.

The control method of a broadcast monitoring system according to the present disclosure adopts an IMC manner with low-power-consumption to realize broadcast monitoring. The designed lightweight target neural network model is transferred to the IMC chip, and the power consumption of the IMC chip is reduced by utilizing the lightweight characteristics. Meanwhile, the recognition precision of a person staring at a screen is improved by combining with a neural network gaze recognition technology, so that the timing for the terminal to enter sleeping or be actively awakened can be more accurately controlled. The power consumption of the system is saved when the display screen enters the sleep state, and the terminal can be kept in a standby state for a long time under the condition that the terminal is not actively awakened, so that the problem of high power consumption is solved, and a large amount of maintenance cost is reduced.

Since the intelligent awakening application scene applying the present disclosure is limited by hardware of the IMC chip, it is required to design a lightweight target neural network model to complete the target detection task. The following describes in detail a training process of the target neural network model according to an embodiment of the present disclosure.

FIG. 2 is a schematic diagram illustrating a network architecture of an exemplary target neural network model according to the embodiment of the present disclosure. In some embodiments, as shown in FIG. 2, the target neural network model includes seven convolutional layers. For example, a first layer convolution layer conv1 employs a convolution kernel with a kernel size of 3×3 for convolution, with a stride of 2 and a padding of 1; a second convolution layer conv2 employs a convolution kernel with a kernel size of 3×3 for convolution, with a stride of 2 and a padding of 1; a third convolution layer conv3 employs a convolution kernel with a kernel size of 3×3 for convolution, with a stride of 1 and a padding of 1; a fourth convolution layer conv4 employs a convolution kernel with a kernel size of 3×3 for convolution, with a stride of 2 and a padding of 1; a fifth convolutional layer conv5 employs a convolution kernel with a kernel size of 7×7 for convolution, with a stride of 2 and a padding of 1; a sixth convolutional layer conv6 employs a convolution kernel with a kernel size of 3×3 for convolution, with a stride of 1 and a padding of 1; and a seventh convolutional layer conv7 employs a convolution kernel of size 3×3 for convolution, with a stride of 2 and a padding of 1.

The target neural network model described above meets the requirement of light weight, is transferred to an IMC chip, and has higher response speed and lower power consumption in the application process thereof.

Since the model is small, direct training the designed model may not achieve a high-precision recognition effect. Therefore, a distillation method for a large model is employed to improve the performance, and the mobilnetv3 with a width of 0.5 times is used as the large model, that is, a teacher network learning model (teacher model). Finally, the larger teacher model is converted into a smaller student network learning model (student model) as a trained target neural network model.

FIG. 3 is a flowchart illustrating how to train a target neural network model according to an embodiment of the present disclosure. In some embodiments, as shown in FIG. 3, a target neural network model is obtained by training through the following steps S21 to S22.

Step S21, training a to-be-trained teacher network learning model according to an acquired training data set, to obtain a trained teacher network learning model.

Here, the training data set may be a labeled public data set and/or gathered video data. However, different from face recognition, in a gaze recognition scene, it is to determine whether the human eye is in a state of gazing at a screen, based on face recognition and further based on information of key points in the face. Therefore, compared with the face recognition scene, the number of positive samples (i.e., gaze samples) in the existing public data set is often smaller. In order to improve the accuracy of model training, a large amount of sample data is needed to support the training, and therefore the training data set of the present disclosure may be a data set where the sample types are further enriched based on the labeled public data set and/or the gathered video data, so that the obtained training images are more diverse. The method of enriching the sample types may refer to the following steps S211-S217, and the detailed process is not described here. The training data set includes a plurality of training images, and each training image includes a corresponding sample label.

Illustratively, a training image in the training data set is input into a to-be-trained teacher network learning model, and an output result corresponding to the training image is obtained, where the output result is a result indicating whether a person gazes at the screen or not. If the sample label of the training image indicates that a person gazes at the screen, a third loss function is determined according to the output result and the sample label of the training image; and the above-described process is repeated, sequentially and throughout the training images in the training data set, to determine the third loss function, so as to continuously train the to-be-trained teacher network learning model, and finally obtain the trained teacher network learning model.

Step S22, training a to-be-trained student network learning model by a knowledge distillation training method, according to the training data set and the trained teacher network learning model, to obtain a trained student network learning model as the target neural network model.

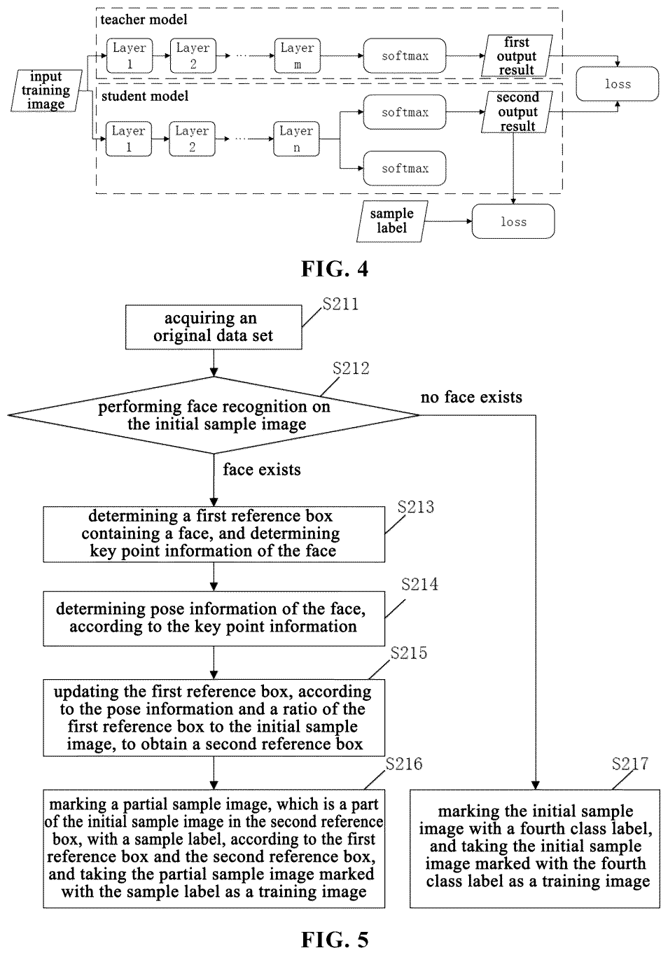

FIG. 4 is a schematic diagram illustrating a network architecture of exemplary knowledge distillation according to an embodiment of the present disclosure. As shown in FIG. 4, the knowledge distillation includes a teacher model and a student model, where the teacher model includes m network layers; and the student model includes n network layers. Here, the teacher model and the student model each may be a homogeneous network or a heterogeneous network.

In the process of training the student model, the teacher model is trained through hard labels (namely, sample labels carried by training images) in the training data set, and then soft labels obtained in the teacher model (namely, output passing through a softmax layer in the teacher model) are combined with the hard labels in the training data set, to determine together a loss function of the student model.

Continuing to refer to FIG. 4, an output result of an m^{th} network layer Layer m of the teacher model is processed through a softmax layer, to obtain a first output result; and an output result of an nth network layer Layer n of the student model is processed through a softmax layer, to obtain a second output result. A loss function loss is constructed according to the first output result, the second output result and the sample label.

In this embodiment, a knowledge distillation method is adopted to convert a larger teacher model into a smaller student model and retain the performance close to the teacher model, so that the problem of insufficient deployment of hardware of the target neural network model at an edge section is solved.

The specific training process may refer to steps S221 to S226.

Step S221, inputting the training image into the trained teacher network learning model, to obtain a first output result of the trained teacher network learning model.

Illustratively, a training image A in the training data set is input into the trained teacher network learning model, to obtain a first output result corresponding to the training image A, where the first output result is a result output by the trained teacher network learning model and indicating whether a person gazes at the screen in the training image A, for example, a prediction label of the training image A predicted by the trained teacher network learning model.

Step S222, inputting the training image into the to-be-trained student network learning model, to obtain a second output result of the to-be-trained student network learning model.

Continuing from the above example, the training image A in the training data set is input into the to-be-trained student network learning model, to obtain a second output result corresponding to the training image A, where the second output result is a result output by the to-be-trained student network learning model and indicating whether a person gazes at the screen in the training image A, for example, a prediction label of the training image A predicted by the to-be-trained student network learning model.

It should be noted that a same training image corresponds to a group of the first output result and the second output result.

Step S223, determining a first loss function, according to the first output result and the second output result.

A mean square error of a group of the first output result and the second output result corresponding to the same training image is calculated, according to the first output result and the second output result, and is taken as a first loss function. Alternatively, the first loss function is determined through a KLD loss function algorithm (namely KLDloss), according to a group of the first output result and the second output result corresponding to the same training image.

Step S224, determining a second loss function, according to the second output result and a sample label of the training image.

The second loss function may be determined according to Intersection Over Union (IOU) of the second output result (i.e., the predicted label of the training image A predicted by the to-be-trained student network learning model) and the sample label of the training image (i.e., the real hard label).

Step S225, obtaining a weighted loss function, according to the first loss function and the second loss function.

The first loss function and the second loss function are weighted according to the preset weights, to obtain the weighted loss function. Here, the preset weights may be determined empirically, which is not particularly limited in the embodiment of the present disclosure.

Proportion coefficients of the first loss function and the second loss function are acquired. In this embodiment, since the weighted loss function is composed of the first loss function and the second loss function, when one of the proportion coefficients (α) is determined, the other proportion coefficient (i.e., 1-α) may be determined. Then, the first loss function L1 and the second loss function L2 are weighted and summed according to the proportion coefficients, and the weighted loss function is determined. In conjunction with the above description, the weighted loss function L may be expressed specifically as: L=α×L1+ (1−α)×L2.

Step S226, adjusting parameters of the to-be-trained student network learning model according to the weighted loss function, until the weighted loss function is converged, to obtain the trained student network learning model as the target neural network model.

In addition, the lightweight model often has the problem of insufficient detection accuracy while reducing the system power consumption. In order to improve the recognition accuracy of the lightweight target neural network model, the training process of the model is improved in the present disclosure. Specifically, diversified training images are improved in terms of training samples, and the model is trained by utilizing the training images corresponding to various class labels, so that the training accuracy of the target neural network model is improved.

In some embodiments, the training data set may be a data set where the sample types are further enriched based on the original data set. FIG. 5 is a flowchart illustrating how to generate a training data set according to an embodiment of the present disclosure. As shown in FIG. 5, specifically generating diversified training images includes steps S211 to S217.

Step S211, acquiring an original data set.

The original data set includes a plurality of initial sample images.

Step S212, performing face recognition on the initial sample image. If a face exists, step S213 is executed; and if no face exists, step S217 is executed.

For example, face recognition may be performed on the initial sample image, through a model such as a face detection network retinaface or a neural network yolov5.

Step S213, determining a first reference box containing a face, and determining key point information of the face.

Under the condition that the face exists in the initial sample image, a first reference box is marked for an area where the face is located such that the face is bounded by the first reference box. Position information of the first reference box indicates a position of the face in the initial sample image.

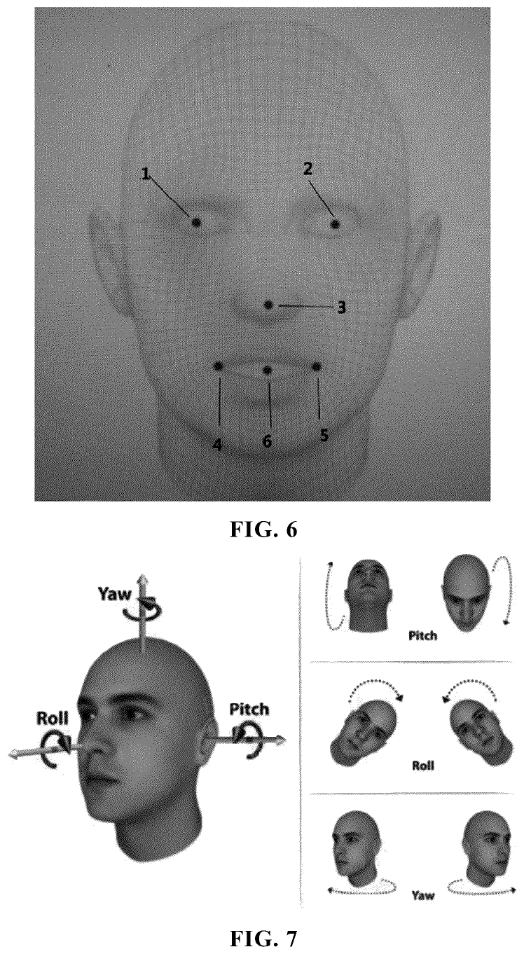

Under the condition that the face exists in the initial sample image, target key points of the face is further determined. The key point information represents coordinates of the target key points in the initial sample image. FIG. 6 is a schematic diagram illustrating exemplary summarized target key points on a face according to an embodiment of the present disclosure. As shown in FIG. 6, here, the target key points may be customized according to an actual scene, for example, the target key points may include key points such as a left eye 1, a right eye 2, a nose 3, a left mouth corner 4, a right mouth corner 5, and a center 6 between the left and right mouth corners.

Step S214, determining pose information of the face, according to the key point information.

FIG. 7 is a schematic diagram illustrating different exemplary face poses according to an embodiment of the present disclosure. As shown in FIG. 7, specifically, a pose estimation algorithm (for example, a pose estimation algorithm in POSIT of OpenCV) may be used to project the six target key points (3D key points) in the world coordinate system to five 2D key points, through changes such as rotation and translation, and then obtain transformation parameters through estimation, and finally obtain pose information of the face in a 2D plane, for example, information such as pitch angle, yaw angle, roll angle, and the like of the face.

Subsequently, combining with pose information from multiple angles, the accuracy of the sample label of the training image can be improved, thereby improving the model training precision.

Step S215, updating the first reference box, according to the pose information and a ratio of the first reference box to the initial sample image, to obtain a second reference box.

The first reference boxes are correspondingly updated in different manners, according to different pose information and/or different ratios of the first reference box to the initial sample image, thereby obtaining different second reference boxes. The specific manner for updating may be, for example, randomly moving a specific coordinate point.

In one embodiment, the pose information includes pitch, yaw, and roll angles of the face.

Under the conditions that the ratio of the first reference box to the initial sample image is greater than or equal to a first preset threshold value, the pitch angle of the face is less than or equal to a first set value, the yaw angle of the face is less than or equal to a second set value, and the roll angle of the face is less than or equal to a third set value, the specific coordinate point in the first reference box is moved in accordance with a first set range, according to the position information of the first reference box, to obtain the second reference box.

The first preset threshold value, the first set value, the second set value and the third set value may be set according to an actual application scene. Illustratively, the first preset threshold value is set to 50%, the first set value is set to 25°, the second set value is set to 25°, and the third set value is set to 45°. That is, under the conditions that the ratio of the first reference box to the initial sample image is greater than or equal to 50%, the yaw angle of the face is less than or equal to 25°, the pitch angle of the face is less than or equal to 25°, and the roll angle of the face is less than or equal to 45°, it is determined that the person is in the state of gazing at the screen at this time.

Here, under the conditions that the ratio of the first reference box to the initial sample image is greater than or equal to the first preset threshold value, the pitch angle of the face is less than or equal to the first set value, the yaw angle of the face is less than or equal to the second set value, and the roll angle of the face is less than or equal to the third set value, it may be determined that the sample label to be marked is a first class label, and the first class label is a label for representing gaze. It should be noted that, here, only the sample label to be marked is determined, and the process is not a marking process. According to the fact that the currently determined sample label to be marked is a first class label, a first set range corresponding to the first class label is determined. A mapping relationship between the first class label and the first set range is preset.

Then, the specific coordinate point in the first reference box is moved in accordance with the first set range, according to the position information of the first reference box, to obtain the second reference box. Here, the first set range corresponding to the first class label may be a movement range of the specific coordinate point, which is set in advance. The specific coordinate point may be a vertex of an outer contour of the first reference box, such as vertex 1 at the upper left corner, vertex 2 at the upper right corner, vertex 3 at the lower left corner, or vertex 4 at the lower right corner. In this embodiment, vertex 1 at the upper left corner and vertex 4 at the lower right corner may be selected as specific coordinate points to perform diversified updating of the reference box.

Illustratively, coordinates of vertex 1 at the upper left corner are (ltₓ, lt_{y}), coordinates of vertex 4 at the lower right corner are (rbₓ, rb_{y}); random moving values of the coordinates (ltₓ, lt_{y}) are set to δₓ, δ_{y}; and random moving values of the coordinates (rbₓ, rb_{y}) of vertex 4 are set to σₓ, σ_{y}, where these values may be positive or negative. After random movement, coordinates of new vertex 1 are (lt1ₓ, lt1_{y}), that is,

$$lt {1}_{x} = {lt}_{x} + {δ}_{x}$$

$$lt {1}_{y} = {lt}_{y} + {δ}_{y}$$

and coordinates of new vertex 4 are (rb1ₓ, rb1_{y}), that is,

$$rb {1}_{x} = {rb}_{x} + {σ}_{x}$$

$$rb {1}_{y} = {rb}_{y} + {σ}_{y}$$

where the first set range include ranges of δₓ, δ_{y}, σₓ and σ_{y}, for example, δₓ∈[−w1,0], δ_{y}∈[−h1,0], σₓ∈[0, rw1], and σ_{y}∈[0, h1], where w1=(rbₓ-ltₓ)×0.8; and h1=(rb_{y}−lt_{y})×0.5. When the specific coordinate point is moved according to the first set range, the first reference box correspondingly expands outward, and expansion range thereof is relatively small to ensure better gaze effect of the face within the second reference box.

In one embodiment, the pose information includes pitch, yaw, and roll angles of the face.

Under the conditions that the ratio of the first reference box to the initial sample image is greater than or equal to a first preset threshold value, the pitch angle of the face is greater than a first set value, the yaw angle of the face is greater than a second set value, and the roll angle of the face is greater than a third set value, the specific coordinate point in the first reference box is moved in accordance with a second set range, according to the position information of the first reference box, to obtain the second reference box.

The first preset threshold value, the first set value, the second set value and the third set value may be set according to an actual application scene. Illustratively, the first preset threshold value is set to 50%, the first set value is set to 25°, the second set value is set to 25°, and the third set value is set to 45°. That is, under the conditions that the ratio of the first reference box to the initial sample image is greater than or equal to 50%, the yaw angle of the face is greater than 25°, the pitch angle of the face is greater than 25°, and the roll angle of the face is greater than 45°, it is determined that the person is not in the state of gazing at the screen at this time.

Here, under the conditions that the ratio of the first reference box to the initial sample image is greater than or equal to the first preset threshold value, the pitch angle of the face is greater than the first set value, the yaw angle of the face is greater than the second set value, and the roll angle of the face is greater than the third set value, it may be determined that the sample label to be marked is a second class label, and the second class label is a label for representing non-gaze. It should be noted that, here, only the sample label to be marked is determined, and the process is not a marking process. According to the fact that the currently determined sample label to be marked is a second class label, a second set range corresponding to the second class label is determined. A mapping relationship between the second class label and the second set range is set in advance.

Then, the specific coordinate point in the first reference box is moved in accordance with the second set range, according to the position information of the first reference box, to obtain the second reference box. Here, the second set range corresponding to the second class label may be a movement range of the specific coordinate point, which is set in advance. The specific coordinate point may be a vertex of an outer contour of the first reference box, such as vertex 1 at the upper left corner, vertex 2 at the upper right corner, vertex 3 at the lower left corner, or vertex 4 at the lower right corner. In this embodiment, vertex 1 at the upper left corner and vertex 4 at the lower right corner may be selected as specific coordinate points to perform diversified updating of the reference box.

Illustratively, coordinates of vertex 1 at the upper left corner are (ltₓ, lt_{y}), coordinates of vertex 4 at the lower right corner are (rbₓ, rb_{y}); random moving values of the coordinates (ltₓ, lt_{y}) are set to δₓ, δ_{y}; and random moving values of the coordinates (rbₓ, rb_{y}) of vertex 4 are set to σₓ, σ_{y}, where these values may be positive or negative. After random movement, coordinates of new vertex 1 are (lt1ₓ, lt1_{y}), that is,

$$lt {1}_{x} = {lt}_{x} + {δ}_{x}$$

$$lt {1}_{y} = {lt}_{y} + {δ}_{y}$$

and coordinates of new vertex 4 are (rb1ₓ, rb1_{y}), that is,

$$rb {1}_{x} = {rb}_{x} + {σ}_{x}$$

$$rb {1}_{y} = {rb}_{y} + {σ}_{y}$$

where the second set range may be the same as or different from the first set range. In the present disclosure, the second set range being the same as the first set range is taken as an example for explanation. The second set range include ranges of δₓ, δ_{y}, σₓ and σ_{y}, for example, δₓ∈[−w1,0], δ_{y}∈[−h1,0], σₓ∈[0, rw1], and σ_{y}∈[0, h1], where w1=(rbₓ−ltₓ)×0.8; and h1=(rb_{y}−lt_{y})×0.5. When the specific coordinate point is moved according to the second set range, the first reference box correspondingly expands outward, and expansion range thereof is relatively small to ensure sample diversity of non-gaze effects within the second reference box, thereby improving the accuracy of subsequent determination of positive and negative samples.

In one embodiment, the pose information includes pitch, yaw, and roll angles of the face.

Under the condition that the ratio of the first reference box to the initial sample image is less than a first preset threshold value and greater than a second preset threshold value, the specific coordinate point in the first reference box is moved in accordance with a third set range, according to the position information of the first reference box, to obtain the second reference box, where the first preset threshold value is greater than the second preset threshold value.

The first preset threshold value and the second preset threshold value may be set according to an actual application scene. For example, the first preset threshold value may be set to 50%, and the second preset threshold value may be 0. That is, under the condition that the ratio of the first reference box to the initial sample image is less than 50% and greater than 0, it is determined that the person is in the state of not gazing at the screen at this time.

Here, under the condition that the ratio of the first reference box to the initial sample image is less than the first preset threshold value and greater than the second preset threshold value, it may be determined that the sample label to be marked is a third class label, and the third class label is a label for representing non-gaze. It should be noted that, here, only the sample label to be marked is determined, and the process is not a marking process. According to the fact that the currently determined sample label to be marked is a third class label, a third set range corresponding to the third class label is determined. A mapping relationship between the third class label and the third set range is set in advance.

Then, the specific coordinate point in the first reference box is moved in accordance with the third set range, according to the position information of the first reference box, to obtain the second reference box. Here, the third set range corresponding to the third class label may be a movement range of the specific coordinate point, which is set in advance. The specific coordinate point may be a vertex of an outer contour of the first reference box, such as vertex 1 at the upper left corner, vertex 2 at the upper right corner, vertex 3 at the lower left corner, or vertex 4 at the lower right corner. In this embodiment, vertex 1 at the upper left corner and vertex 4 at the lower right corner may be selected as specific coordinate points to perform diversified updating of the reference box.

Illustratively, coordinates of vertex 1 at the upper left corner are (ltₓ, lt_{y}), coordinates of vertex 4 at the lower right corner are (rbₓ, rb_{y}); random moving values of the coordinates (ltₓ, lt_{y}) are set to δₓ, δ_{y}; and random moving values of the coordinates (rbₓ, rb_{y}) of vertex 4 are set to σₓ, σ_{y}, where these values may be positive or negative. After random movement, coordinates of new vertex 1 are (lt1ₓ, lt1_{y}), that is,

$$lt {1}_{x} = {lt}_{x} + {δ}_{x}$$

$$lt {1}_{y} = {lt}_{y} + {δ}_{y}$$

and coordinates of new vertex 4 are (rb1ₓ, rb1_{y}), that is,

$$rb {1}_{x} = {rb}_{x} + {σ}_{x}$$

$$rb {1}_{y} = {rb}_{y} + {σ}_{y}$$

where the third set range include ranges of δₓ, δ_{y}, σₓ and σ_{y}, for example, δₓ ∈[−w2, −w3], δ_{y}∈[−h2, −h3], σₓ∈[w3, w2], and σ_{y}∈[h3, h2], where w2−(rbₓ−ltₓ)×2.5; w3=(rbₓ−ltₓ)×0.8; h2=(rb_{y}−lt_{y})×2.5, and h3=(rb_{y}−lt_{y})×0.8. When the specific coordinate point is moved according to the third set range, the first reference box correspondingly expands outward, and expansion range thereof is greater than the first set range, to ensure better non-gaze effect of the face within the second reference box. Furthermore, based on the non-gaze effect corresponding to the second set range, the sample diversity of non-gaze effects of the face is further improved, thereby enhancing the accuracy of subsequent determination of positive and negative samples.

In the present disclosure, as shown in the above embodiments, the gaze state and the non-gaze state (for example, a state corresponding to the first class label belongs to the gaze state, and states corresponding to the second class label and the third class label each belong to the non-gaze state) are refined, according to the ratio of the first reference box to the initial sample image and the pose information of the face, thereby improving the accuracy of subsequent determination of positive and negative samples.

Step S216, marking a partial sample image, which is a part of the initial sample image in the second reference box, with a sample label, according to the first reference box and the second reference box, and taking the partial sample image marked with the sample label as a training image.

For the specific implementation of step S215, the determined sample labels include a first class label for representing gaze, and second and third class labels for representing non-gaze. The first class label indicates that the pitch angle of the face is less than or equal to a first set value, the yaw angle of the face is less than or equal to a second set value, or the roll angle of the face is less than or equal to a third set value, when the ratio of the second reference box in the training image to the training image is greater than or equal to a first preset threshold value. The second class label indicates that the pitch angle of the face is greater than the first set value, the yaw angle of the face is greater than the second set value, or the roll angle of the face is greater than the third set value, when the ratio of the second reference box in the training image to the training image is greater than or equal to the first preset threshold value. The third class label indicates that the ratio of the second reference box in the training image to the training image is less than the first preset threshold value and greater than a second preset threshold value.

In one embodiment, under the conditions that the ratio of the first reference box to the initial sample image is greater than or equal to the first preset threshold value, the pitch angle of the face is less than or equal to the first set value, the yaw angle of the face is less than or equal to the second set value, and the roll angle of the face is less than or equal to the third set value, the specific process of marking with the first class label may include:
determining an overlapping area between the second reference box and the first reference box, according to the position information of the second reference box and the position information of the first reference box.

It should be noted that, since the second reference box is obtained by expanding the first reference box outward, the larger the overlapping area between the second reference box and the first reference box is, the greater a ratio of the face in the second reference box to the entire second reference box is.

In order to balance the number of positive samples, under the condition that a first ratio of the overlapping area to an area of the second reference box is greater than or equal to a third preset threshold value, a first preset range is generated a according to a first preset probability, a second preset range is generated according to a second preset probability, a third preset range is generated according to a third preset probability, and a fourth preset range is generated according to a fourth preset probability; where the first preset probability is greater than the second preset probability, the second preset probability is greater than the third preset probability, and the third preset probability is greater than or equal to a fourth preset probability; and a sum of the first preset probability, the second preset probability, the third preset probability and the fourth preset probability is 1.

Then, according to the preset ranges controlled by the preset probabilities, when the first ratio is within the first preset range, a partial sample image, which is a part of the initial sample image in the second reference box, is determined and marked with a first class label, such that a second ratio of the number of training images with the first ratio within the first preset range and marked with the first class label to the total number of all the training images marked with the first class label in the training data set is the first preset probability; when the first ratio is within the second preset range, a partial sample image, which is a part of the initial sample image in the second reference box, is determined and marked with a first class label, such that a second ratio of the number of training images with the first ratio within the second preset range and marked with the first class label to the total number of all the training images marked with the first class label in the training data set is the second preset probability; when the first ratio is within the third preset range, a partial sample image, which is a part of the initial sample image in the second reference box, is determined and marked with a first class label, such that a second ratio of the number of training images with the first ratio within the third preset range and marked with the first class label to the total number of all the training images marked with the first class label in the training data set is the third preset probability; when the first ratio is within the fourth preset range, a partial sample image, which is a part of the initial sample image in the second reference box, is determined and marked with a first class label, such that a second ratio of the number of training images with the first ratio within the fourth preset range and marked with the first class label to the total number of all the training images marked with the first class label in the training data set is the fourth preset probability.

Data in the first preset range are less than data in the second preset range, the data in the second preset range are less than data in the third preset range, and the data in the third preset range are less than data in the fourth preset rangege.

Illustratively, the third preset threshold value is set to 0.5; if the first ratio is greater than or equal to 0.5, a first preset range of 0.5 to 0.7 (excluding 0.7) is selected according to a probability of 50% (first preset probability), a second preset range of 0.7 to 0.8 (excluding 0.8) is selected according to a probability of 30% (second preset probability), a third preset range of 0.8 to 0.9 (excluding 0.9) is selected according to a probability of 10% (third preset probability), and a fourth preset range of 0.9 to 1.0 is selected according to a probability of 10% (fourth preset probability). When the first ratio is within the first preset range, the partial sample image in the second reference box is marked with a first class label, such that a finally obtained second ratio of the number of training images with the first ratio within the first preset range and marked with the first class label to the total number of all the training images marked with the first class label in the training data set is 50%. When the first ratio is within the second preset range, the partial sample image in the second reference box is marked with a first class label, such that a finally obtained second ratio of the number of training images with the first ratio within the second preset range and marked with the first class label to the total number of all the training images marked with the first class label in the training data set is 30%; when the first ratio is within the third preset range, the partial sample image in the second reference box is marked with a first class label, such that a finally obtained second ratio of the number of training images with the first ratio within the third preset range and marked with the first class label to the total number of all the training images marked with the first class label in the training data set is 10%; when the first ratio is within the fourth preset range, the partial sample image in the second reference box is marked with a first class label, such that a finally obtained second ratio of the number of training images with the first ratio within the fourth preset range and marked with the first class label to the total number of all the training images marked with the first class label in the training data set is 10%.

In this embodiment, through controlling the proportions of the positive samples corresponding to different first ratios, it is avoided that face features appear everywhere in each positive sample training image, and the diversity of the positive samples is improved.

In one embodiment, under the conditions that the ratio of the first reference box to the initial sample image is greater than or equal to the first preset threshold value, the pitch angle of the face is greater than the first set value, the yaw angle of the face is greater than the second set value, and the roll angle of the face is greater than the third set value, the specific process of marking with the second class label may include:
determining an overlapping area between the second reference box and the first reference box, according to the position information of the second reference box and the position information of the first reference box.

It should be noted that, since the second reference box is obtained by expanding the first reference box outward, the larger the overlapping area between the second reference box and the first reference box is, the greater a ratio of the face in the second reference box to the entire second reference box is.

Under the condition that a third ratio of the overlapping area to an area of the second reference box is greater than or equal to a third preset threshold value, a first preset range is generated according to the first preset probability, a second preset range is generated according to the second preset probability, a third preset range is generated according to a third preset probability, and a fourth preset range is generated according to a fourth preset probability; where the first preset probability is greater than the second preset probability, the second preset probability is greater than the third preset probability, and the third preset probability is greater than or equal to the fourth preset probability; and a sum of the first preset probability, the second preset probability, the third preset probability and the fourth preset probability is 1.

Then, according to the preset ranges controlled by the preset probabilities, when the third ratio is in the first preset range, a partial sample image, which is a part of the initial sample image in the second reference box, is determined and marked with a second class label, such that a fourth ratio of the number of training images with the third ratio within the first preset range and marked with the second class label to the total number of all the training images marked with the second class label in the training data set is the first preset probability; when the third ratio is within the second preset range, a partial sample image, which is a part of the initial sample image in the second reference box, is determined and marked with a second class label, such that a fourth ratio of the number of training images with the third ratio within the second preset range and marked with the second class label to the total number of all the training images marked with the second class label in the training data set is the second preset probability; when the third ratio is within the third preset range, a partial sample image, which is a part of the initial sample image in the second reference box, is determined and marked with a second class label, such that a fourth ratio of the number of training images with the third ratio within the third preset range and marked with the second class label to the total number of all the training images marked with the second class label in the training data set is the third preset probability; and when the third ratio is within the fourth preset range, a partial sample image, which is a part of the initial sample image in the second reference box, is determined and marked with a second class label, such that a fourth ratio of the number of training images with the third ratio within the fourth preset range and marked with the second class label to the total number of all the training images marked with the second class label in the training data set is the fourth preset probability.

Data in the first preset range are less than data in the second preset range, the data in the second preset range are less than data in the third preset range, and the data in the third preset range are less than data in the fourth preset rangege.

Illustratively, the third preset threshold value is set to 0.5; if the third ratio is greater than or equal to 0.5, a first preset range of 0.5 to 0.7 (excluding 0.7) is selected according to a probability of 50% (first preset probability), a second preset range of 0.7 to 0.8 (excluding 0.8) is selected according to a probability of 30% (second preset probability), a third preset range of 0.8 to 0.9 (excluding 0.9) is selected according to a probability of 10% (third preset probability), and a fourth preset range of 0.9 to 1.0 is selected according to a probability of 10% (fourth preset probability). When the third ratio is within the first preset range, the partial sample image in the second reference box is marked with a second class label, such that a finally obtained fourth ratio of the number of training images with the third ratio within the first preset range and marked with the second class label to the total number of all the training images marked with the second class label in the training data set is 50%. When the third ratio is within the second preset range, the partial sample image in the second reference box is marked with a second class label, such that a finally obtained fourth ratio of the number of training images with the third ratio within the second preset range and marked with the second class label to the total number of all the training images marked with the second class label in the training data set is 30%. When the third ratio is within the third preset range, the partial sample image in the second reference box is marked with a second class label, such that a finally obtained fourth ratio of the number of training images with the third ratio within the third preset range and marked with the second class label to the total number of all the training images marked with the second class label in the training data set is 10%. When the third ratio is within the fourth preset range, the partial sample image in the second reference box is marked with a second class label, such that a finally obtained fourth ratio of the number of training images with the third ratio within the fourth preset range and marked with the second class label to the total number of all the training images marked with the second class label in the training data set is 10%.

The above is the process of preparing the negative examples corresponding to the second class label. In this embodiment, through controlling the proportions of the negative samples corresponding to different third ratios, it is allowed that the prepared training image is a sample which has a large occupation ratio of face and is in a non-gaze state, and the diversity of the negative samples is improved.

In one embodiment, under the condition that the ratio of the first reference box to the initial sample image is less than a first preset threshold value and greater than a second preset threshold value, the specific process of marking with the third class label may include:
determining an overlapping area between the second reference box and the first reference box, according to the position information of the second reference box and the position information of the first reference box.

Under the condition that a fifth ratio of the overlapping area to an area of the second reference box is less than a third preset threshold value, a fifth preset range is generated according to a fifth preset probability, a sixth preset range is generated according to a sixth preset probability, and a seventh preset range is generated according to a seventh preset probability; where the fifth preset probability is greater than the sixth preset probability, and the sixth preset probability is greater than the seventh preset probability; and a sum of the fifth preset probability, the sixth preset probability and the seventh preset probability is 1.

Then, according to the preset ranges controlled by the preset probabilities, a partial sample image, which is a part of the initial sample image in the second reference box, is marked with a third class label, and when the fifth ratio is in a fifth preset range, a partial sample image, which is a part of the initial sample image in the second reference box, is determined and marked with a third class label, such that a sixth ratio of the number of training images with the fifth ratio within the fifth preset range and marked with the third class label to the total number of all the training images marked with the third class label in the training data set is the fifth preset probability; when the fifth ratio is within a sixth preset range, a partial sample image, which is a part of the initial sample image in the second reference box, is determined and marked with a third class label, such that a sixth ratio of the number of training images with the sixth ratio within the sixth preset range and marked with the third class label to the total number of all the training images marked with the third class label in the training data set is the sixth preset probability; when the fifth ratio is within a seventh preset range, a partial sample image, which is a part of the initial sample image in the second reference box, is determined and marked with a third class label, such that a sixth ratio of the number of training images with the sixth ratio within the seventh preset range and marked with the third class label to the total number of all the training images marked with the third class label in the training data set is the seventh preset probability; where data in the seventh preset range is less than data in the sixth preset range, and the data in the sixth preset range is less than data in the fifth preset range.

Illustratively, the third preset threshold value is set to 0.5; if the fifth ratio is less than 0.5, a fifth preset range of 0.25 to 0.5 (excluding 0.5) is selected according to a probability of 60% (fifth preset probability), a sixth preset range of 0.15 to 0.25 (excluding 0.25) is selected according to a probability of 30% (sixth preset probability), and a seventh preset range of 0.01 to 0.15 is selected according to a probability of 10% (seventh preset probability). When the fifth ratio is within a fifth preset range, the partial sample image in the second reference box is determined and marked with a third class label, such that a finally obtained sixth ratio of the number of training images with the fifth ratio within the fifth preset range and marked with the third class label to the total number of all the training images marked with the third class label in the training data set is 60%. When the fifth ratio is within a sixth preset range, the partial sample image in the second reference box is determined and marked with a third class label, such that a finally obtained sixth ratio of the number of training images with the fifth ratio within the sixth preset range and marked with the third class label to the total number of all the training images marked with the third class label in the training data set is 30%. When the fifth ratio is within a seventh preset range, the partial sample image in the second reference box is determined and marked with a third class label, such that a finally obtained sixth ratio of the number of training images with the fifth ratio within the seventh preset range and marked with the third class label to the total number of all the training images marked with the third class label in the training data set is 10%.

The above is the process of preparing the negative examples corresponding to the third class label. In this embodiment, through controlling the proportions of the negative samples corresponding to different ratios of the overlapping area to the area of the second reference box, it is allowed that the prepared training image is a sample which has a small occupation ratio of face and is in a non-gaze state, and the diversity of the negative samples is improved.

Step S217, marking the initial sample image with a fourth class label, and taking the initial sample image marked with the fourth class label as a training image.

The sample labels further include the fourth class label for representing non-gaze.

In some embodiments, after the step S212 is executed, the method further includes: determining a target central point in the initial sample image in accordance with a fourth set range, according to a size of the initial sample image, and determining a third reference box with the target central point as a center; if the third reference box is not overlapped with any first reference box in the initial sample image, marking a partial sample image, which is a part of the initial sample image in the third reference box, with a fourth class label, and taking the partial sample image marked with the fourth class label as a training image.

Here, through randomly setting the target central point in the initial sample image and defining the third reference box, a partial sample image at a position corresponding to the third reference box without the face therein is used as a negative sample training image.

Illustratively, the initial sample image has a width w′ and a height h′; coordinates of the randomly generated target central point are (cnewₓ, cnew_{y}), where cnewₓ ∈[0.05×w′, 0.95×w′], and cnew_{y} ∈[0.05×h′, 0.95×h′]. The randomly generated third reference box has a width wnew and a height hnew, where wnew∈[w′×0.1, w′×0.9], and hnewE [h′×0.1, h′×0.9], thereby determining the third reference box. If the third reference box is not overlapped with any first reference box in the initial sample image, it indicates that no face exists in the third reference box, then a partial sample image, which is a part of the initial sample image in the third reference box, may be marked with a fourth class label, and the partial sample image marked with the fourth class label may be tanken as a training image.

It will be understood by one of ordinary skill in the art that in the above method of the present embodiment, the order to describe the respective steps does not imply a strict execution order to execute the respective steps and does not impose any limitations on the implementation. The specific execution order of the respective steps should be determined by their function and possibly inherent logic.

It should be noted that, except for the gaze detection and awakening a device for operation mentioned in the embodiment of the present disclosure, the portable intelligent terminal application service in the smart home and the wearable device may also adopt such an energy-efficient IMC manner, thereby reducing a lot of costs. With the development of storage and computing technology, a larger deep learning model can be supported, and wider and universal services can be supported. In addition, since functions and operators supported by different storage and computing platforms are different, a network may be built according to the design of an actual hardware platform in the present disclosure, which is not limited to the target neural network model provided by the present disclosure.

In addition, an embodiment of the present disclosure further provides another control method of a broadcast monitoring system, where the execution subject of the control method of a broadcast monitoring system may be the broadcast monitoring system, and the broadcast monitoring system includes a detection apparatus and a terminal. The detection apparatus may be, for example, an IMC chip integrated with Flash or SRAM. The control method of a broadcast monitoring system includes:
by the detection apparatus, acquiring a detected image and performing gaze recognition on the detected image through a pre-trained target neural network model, to obtain a recognition result of the detected image; and sending the recognition result to the terminal; and
determining, by the terminal, a display state based on the recognition result.

The embodiment of the present disclosure provides a control method of a broadcast monitoring system, which utilizes a high-precision gaze recognition result to control the display state of a terminal. For example, if nobody stares at the screen for a long time, the terminal automatically enters a sleep state, so that the power consumption of the system is saved; if during the sleep state, the recognition result indicates that a person staring at the screen emerges, the system can be automatically started, and normal display of the screen is recovered. The present disclosure is applied to an intelligent awakening scene in a gaze environment (such as an environment where a person gazes at a display screen), saves system power consumption, and simultaneously improves the recognition precision of the person staring at the screen by combining with a neural network gaze recognition technology, so that the timing for the terminal to enter sleeping or be actively awakened can be more accurately controlled.

In some embodiments, the terminal includes a display module and a main control module, and the determining, by the terminal, a display state based on the recognition result, includes:
sending, by the main control module, an awakening request to the display module under the condition that the recognition result indicates that an object gazes; sending, by the main control module, a sleep request to the display module under the conditions that the recognition result indicates that no object gazes and it is longer than a preset duration from the latest awakening time of the display module to the current system time; determining, by the display module, that the display state is normal display, in response to the awakening request; and determining, by the display module, that the display state is sleep, in response to the sleep request.

Here, the preset duration may be set according to experience. It should be noted that if the preset duration is reasonably set, it is allowed that the terminal reasonably enters a sleep state in an actual application scene. If the preset duration is too short, it may cause frequent switching between sleep and awakening states, which is not beneficial to reducing power consumption. If the preset duration is too long, the power consumption of the terminal cannot be reduced to the maximum extent.

Here, the display module may be, for example, a display screen, and the main control module may be, for example, a System On Chip (SOC). The main control module and the detection apparatus may communicate with each other through a protocols such as UART.

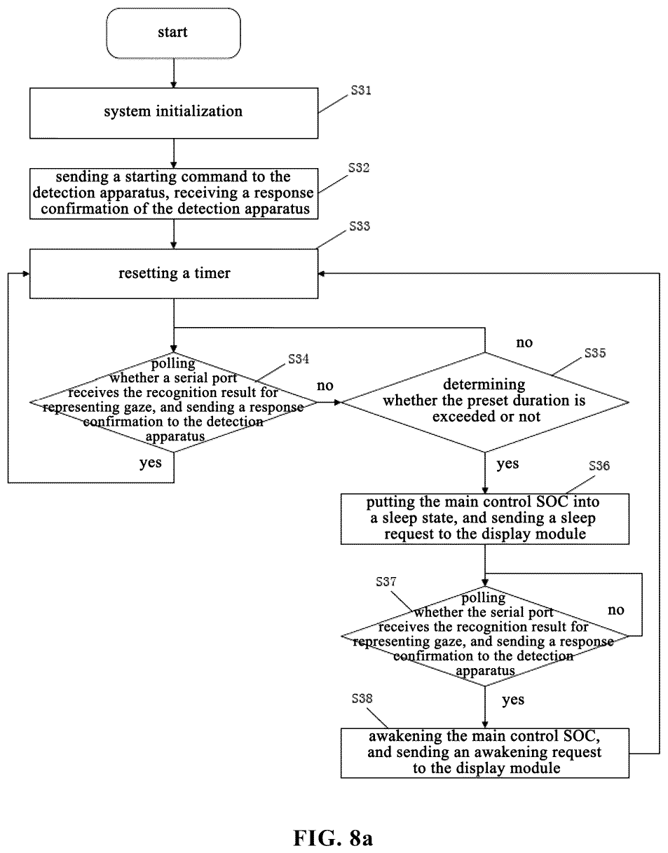

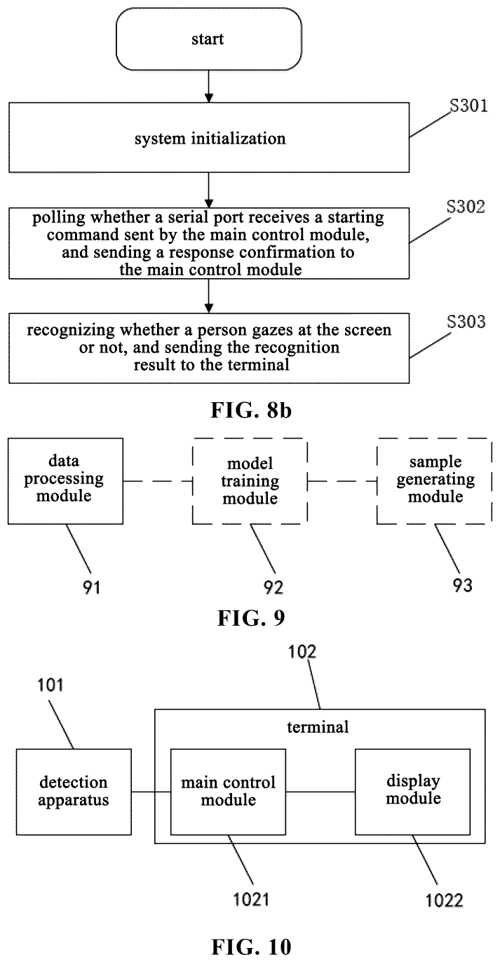

FIG. 8a is a flowchart illustrating operation of an exemplary terminal according to an embodiment of the present. As shown in FIG. 8a, a main control module performs: step S31, starting system initialization; step S32, sending a starting command to the detection apparatus, and receiving a response confirmation of the detection apparatus, and sequentially executing S33; step S33, resetting a timer; step S34, polling whether a serial port receives the recognition result for representing gaze, and sending a response confirmation to the detection apparatus; if yes, returning to execute step S33; if no, executing step S35; step S35, determining whether the preset duration is exceeded or not; if yes, executing step S36; if no, returning to execute step S34; step S36, putting the main control module SOC into a sleep state, and sending a sleep request to the display module, and sequentially executing step S37; step S37, polling whether the serial port receives the recognition result for representing gaze, and sending a response confirmation to the detection apparatus; if yes, executing step S38; if no, repeating to execute step S37; and step S38, awakening the main control module SOC, and sending an awakening request to the display module, and returning to step S33.

FIG. 8b is a flowchart illustrating operation of an exemplary detection apparatus according to an embodiment of the present disclosure. As shown in FIG. 8b, the detection apparatus performs: step S301, starting system initialization; step S302, polling whether a serial port receives a starting command sent by the main control module, and sending a response confirmation to the main control module, and sequentially executing step S303; and step S303, recognizing whether a person gazes at the screen or not, and sending the recognition result to the terminal.

In some embodiments, a target neural network model is obtained by training through the following steps:
training a to-be-trained teacher network learning model according to an acquired training data set, to obtain a trained teacher network learning model; and
training a to-be-trained student network learning model by a knowledge distillation training method, according to the training data set and the trained teacher network learning model, to obtain a trained student network learning model as the target neural network model.

In some embodiments, the training data set includes a plurality of training images labeled with sample labels; and
training a to-be-trained student network learning model by a knowledge distillation training method, according to a training data set and the trained teacher network learning model, to obtain the trained student network learning model as the target neural network model, includes:
inputting the training image into the trained teacher network learning model, to obtain a first output result of the trained teacher network learning model;
inputting a training image into the to-be-trained student network learning model, to obtain a second output result of the to-be-trained student network learning model;
determining a first loss function, according to the first output result and the second output result;
determining a second loss function, according to the second output result and a sample label of the training image;
obtaining a weighted loss function, according to the first loss function and the second loss function; and
adjusting parameters of the to-be-trained student network learning model according to the weighted loss function, until the weighted loss function is converged, to obtain the trained student network learning model as the target neural network model.

In some embodiments, the training data set is determined through the following steps:
acquiring an original data set, where the original data set includes a plurality of initial sample images;
performing face recognition on the initial sample image, if a face exists, determining a first reference box containing a face, and determining key point information of the face;
determining the pose information of the face, according to the key point information;
updating the first reference box, according to the pose information and a ratio of the first reference box to the initial sample image, to obtain a second reference box; and
marking a partial sample image, which is a part of the initial sample image in the second reference box, with a sample label, according to the first reference box and the second reference box, and taking the partial sample image marked with the sample label as a training image.

The sample labels include a first class label for representing gaze, and a second class label and a third class label for representing non-gaze.

The first class label indicates that the pitch angle of the face is less than or equal to a first set value, the yaw angle of the face is less than or equal to a second set value, and the roll angle of the face is less than or equal to a third set value, when a ratio of the second reference box in the training image to the training image is greater than or equal to a first preset threshold value.

The second class label indicates that the pitch angle of the face is greater than a first set value, the yaw angle of the face is greater than a second set value, and the roll angle of the face is greater than a third set value, when the ratio of the second reference box in the training image to the training image is greater than or equal to the first preset threshold value.

The third class label indicates that the ratio of the second reference box in the training image to the training image is less than the first preset threshold value and greater than a second preset threshold value.

In some embodiments, the pose information includes at least pitch, yaw, and roll angles of the face; and
updating the first reference box, according to the pose information and the ratio of the first reference box to the initial sample image, to obtain the second reference box, includes:

under the conditions that the ratio of the first reference box to the initial sample image is greater than or equal to a first preset threshold value, the pitch angle of the face is less than or equal to a first set value, the yaw angle of the face is less than or equal to a second set value, and the roll angle of the face is less than or equal to a third set value, moving a specific coordinate point in the first reference box in accordance with a first set range, according to the position information of the first reference box, to obtain the second reference box.

In some embodiments, marking a partial sample image, which is a part of the initial sample image in the second reference box, with a sample label, according to the first reference box and the second reference box, and taking the partial sample image marked with the sample label as a training image, includes:
determining an overlapping area between the second reference box and the first reference box, according to the position information of the second reference box and the position information of the first reference box;
under the condition that a first ratio of the overlapping area to an area of the second reference box is greater than or equal to a third preset threshold value, generating a first preset range according to a first preset probability, generating a second preset range according to a second preset probability, generating a third preset range according to a third preset probability, and generating a fourth preset range according to a fourth preset probability; where the first preset probability is greater than the second preset probability, the second preset probability is greater than the third preset probability, and the third preset probability is greater than or equal to the fourth preset probability; and a sum of the first preset probability, the second preset probability, the third preset probability and the fourth preset probability is 1;
when the first ratio is within the first preset range, determining and marking a partial sample image, which is a part of the initial sample image in the second reference box, with a first class label, such that a second ratio of the number of training images with the first ratio within the first preset range and marked with the first class label to the total number of all the training images marked with the first class label in the training data set is the first preset probability;
when the first ratio is within the second preset range, determining and marking a partial sample image, which is a part of the initial sample image in the second reference box, with a first class label, such that a second ratio of the number of training images with the first ratio within the second preset range and marked with the first class label to the total number of all the training images marked with the first class label in the training data set is the second preset probability;
when the first ratio is within the third preset range, determining and marking a partial sample image, which is a part of the initial sample image in the second reference box, with a first class label, such that a second ratio of the number of training images with the first ratio within the third preset range and marked with the first class label to the total number of all the training images marked with the first class label in the training data set is the third preset probability;
when the first ratio is within the fourth preset range, determining and marking a partial sample image, which is a part of the initial sample image in the second reference box, with a first class label, such that a second ratio of the number of training images with the first ratio within the fourth preset range and marked with the first class label to the total number of all the training images marked with the first class label in the training data set is the fourth preset probability;
where data in the first preset range are less than data in the second preset range, the data in the second preset range are less than data in the third preset range, and the data in the third preset range are less than data in the fourth preset range.

In some embodiments, the pose information includes at least pitch, yaw, and roll angles of the face; and
updating the first reference box, according to the pose information and a ratio of the first reference box to the initial sample image, to obtain the second reference box, includes:
under the conditions that the ratio of the first reference box to the initial sample image is greater than or equal to a first preset threshold value, the pitch angle of the face is greater than a first set value, the yaw angle of the face is greater than a second set value, and the roll angle of the face is greater than a third set value, moving a specific coordinate point in the first reference box in accordance with a second set range, according to the position information of the first reference box, to obtain the second reference box.

In some embodiments, marking a partial sample image, which is a part of the initial sample image in the second reference box, with a sample label, according to the first reference box and the second reference box, and taking the partial sample image marked with the sample label as a training image, includes:
determining an overlapping area between the second reference box and the first reference box, according to the position information of the second reference box and the position information of the first reference box;
under the condition that a third ratio of the overlapping area to an area of the second reference box is greater than or equal to a third preset threshold value, generating a first preset range according to a first preset probability, generating a second preset range according to a second preset probability, generating a third preset range according to a third preset probability, and generating a fourth preset range according to a fourth preset probability; where the first preset probability is greater than the second preset probability, the second preset probability is greater than the third preset probability, and the third preset probability is greater than or equal to the fourth preset probability; and a sum of the first preset probability, the second preset probability, the third preset probability and the fourth preset probability is 1;
when the third ratio is within the first preset range, determining and marking a partial sample image, which is a part of the initial sample image in the second reference box, with a second class label, such that a fourth ratio of the number of training images with the third ratio within the first preset range and marked with the second class label to the total number of all the training images marked with the second class label in the training data set is the first preset probability;
when the third ratio is within the second preset range, determining and marking a partial sample image, which is a part of the initial sample image in the second reference box, with a second class label, such that a fourth ratio of the number of training images with the third ratio within the second preset range and marked with the second class label to the total number of all the training images marked with the second class label in the training data set is the second preset probability;
when the third ratio is within the third preset range, determining and marking a partial sample image, which is a part of the initial sample image in the second reference box, with a second class label, such that a fourth ratio of the number of training images with the third ratio within the third preset range and marked with the second class label to the total number of all the training images marked with the second class label in the training data set is the third preset probability;
when the third ratio is within the fourth preset range, determining and marking a partial sample image, which is a part of the initial sample image in the second reference box, with a second class label, such that a fourth ratio of the number of training images with the third ratio within the fourth preset range and marked with the second class label to the total number of all the training images marked with the second class label in the training data set is the fourth preset probability;
where data in the first preset range are less than data in the second preset range, the data in the second preset range are less than data in the third preset range, and the data in the third preset range are less than data in the fourth preset rangege.

In some embodiments, the pose information includes at least pitch, yaw, and roll angles of the face; and
updating the first reference box according to the pose information and the ratio of the first reference box to the initial sample image, to obtain the second reference box, includes:
under the condition that the ratio of the first reference box to the initial sample image is less than the first preset threshold value and greater than a second preset threshold value, moving a specific coordinate point in the first reference box in accordance with a third set range, according to the position information of the first reference box, to obtain the second reference box; where the first preset threshold value is greater than the second preset threshold value.

In some embodiments, marking a partial sample image, which is a part of the initial sample image in the second reference box, with a sample label, according to the first reference box and the second reference box, and taking the partial sample image marked with the sample label as a training image, includes:
determining an overlapping area between the second reference box and the first reference box, according to the position information of the second reference box and the position information of the first reference box;
under the condition that a fifth ratio of the overlapping area to an area of the second reference box is less than a third preset threshold value, generating a fifth preset range according to a fifth preset probability, generating a sixth preset range according to a sixth preset probability, and generating a seventh preset range according to a seventh preset probability; where the fifth preset probability is greater than the sixth preset probability, and the sixth preset probability is greater than the seventh preset probability; and a sum of the fifth preset probability, the sixth preset probability and the seventh preset probability is 1;
when the fifth ratio is within the fifth preset range, determining and marking a partial sample image, which is a part of the initial sample image in the second reference box, with a third class label, such that a sixth ratio of the number of training images with the fifth ratio within the fifth preset range and marked with the third class label to the total number of all the training images marked with the third class label in the training data set is the fifth preset probability;
when the fifth ratio is within the sixth preset range, determining and marking a partial sample image, which is a part of the initial sample image in the second reference box, with a third class label, such that a sixth ratio of the number of training images with the sixth ratio within the sixth preset range and marked with the third class label to the total number of all the training images marked with the third class label in the training data set is the sixth preset probability;
when the fifth ratio is within the seventh preset range, determining and marking a partial sample image, which is a part of the initial sample image in the second reference box, with a third class label, such that a sixth ratio of the number of training images with the sixth ratio within the seventh preset range and marked with the third class label to the total number of all the training images marked with the third class label in the training data set is the seventh preset probability;
where data in the seventh preset range is less than data in the sixth preset range, and the data in the sixth preset range is less than data in the fifth preset range.

In some embodiments, the sample labels further include a fourth class label for representing non-gaze; and
in the step of determining the training data set, under the condition that the face recognition performed on the initial sample image determines that no face exists, the method further includes: marking the initial sample image with a fourth class label, and taking the initial sample image marked with the fourth class label as a training image.

In some embodiments, the sample labels further include a fourth class label for representing non-gaze; and
after the face recognition is performed on the initial sample image to determine that a face exists, and a first reference box containing the face is determined, the method further includes:
determining a target central point in the initial sample image in accordance with a fourth set range, according to a size of the initial sample image, and determining a third reference box with the target central point as a center; and
if the third reference box is not overlapped with any first reference box in the initial sample image, marking a partial sample image, which is a part of the initial sample image in the third reference box, with a fourth class label, and taking the partial sample image marked with the fourth class label as a training image.

In addition, an embodiment of the present disclosure further provides a detection apparatus corresponding to the control method of a broadcast monitoring system in the first aspect. Since a principle of solving the problem of the detection apparatus in the embodiment of the present disclosure is similar to that of the control method of a broadcast monitoring system in the above first aspect in the embodiment of the present disclosure, the implementation of the detection apparatus may refer to the implementation of the corresponding control method in the first aspect, and repeated description is omitted.

FIG. 9 is a schematic diagram illustrating a detection apparatus according to an embodiment of the present disclosure, and as shown in FIG. 9, the detection apparatus includes a data processing module 91. The detection apparatus may be, for example, an IMC chip integrated with Flash or SRAM.

The data processing module 91 is configured to acquire a detected image, and perform gaze recognition on the detected image through a pre-trained target neural network model, to obtain a recognition result of the detected image; and send the recognition result to a terminal, so that the terminal determines a display state based on at least the recognition result.

In some embodiments, the detection apparatus further includes a model training module 92; and the model training module 92 is configured to train a to-be-trained teacher network learning model according to an acquired training data set, to obtain a trained teacher network learning model; and train the to-be-trained student network learning model by a knowledge distillation training method, according to the training data set and the trained teacher network learning model, to obtain a trained student network learning model as the target neural network model.

In some embodiments, the training data set includes a plurality of training images labeled with sample labels; and the model training module 92 is specifically configured to input a training image to the trained teacher network learning model, to obtain a first output result of the trained teacher network learning model; input the training image into the to-be-trained student network learning model, to obtain a second output result of the to-be-trained student network learning model; determine a first loss function, according to the first output result and the second output result; determine a second loss function, according to the second output result and a sample label of the training image; obtain a weighted loss function, according to the first loss function and the second loss function; and adjust parameters of the to-be-trained student network learning model according to the weighted loss function, until the weighted loss function is converged, to obtain the trained student network learning model as the target neural network model.

In some embodiments, the detection apparatus further includes a sample generating module 93, and the sample generating module 93 is configured to acquire an original data set, where the original data set includes a plurality of initial sample images; perform face recognition on the initial sample image, if a face exists, determining a first reference box containing a face, and determining key point information of the face; determine the pose information of the face, according to the key point information; update the first reference box, according to the pose information and a ratio of the first reference box to the initial sample image, to obtain a second reference box; and mark a partial sample image, which is a part of the initial sample image in the second reference box, with a sample label, according to the first reference box and the second reference box, and take the partial sample image marked with the sample label as a training image. The sample labels include a first class label for representing gaze, and a second class label and a third class label for representing non-gaze; where the first class label indicates that the pitch angle of the face is less than or equal to a first set value, the yaw angle of the face is less than or equal to a second set value, and the roll angle of the face is less than or equal to a third set value, when a ratio of the second reference box in the training image to the training image is greater than or equal to a first preset threshold value; the second class label indicates that the pitch angle of the face is greater than a first set value, the yaw angle of the face is greater than a second set value, and the roll angle of the face is greater than a third set value, when the ratio of the second reference box in the training image to the training image is greater than or equal to the first preset threshold value; and the third class label indicates that the ratio of the second reference box in the training image to the training image is less than the first preset threshold value and greater than a second preset threshold value.

In some embodiments, the pose information includes at least pitch, yaw, and roll angles of the face; and the sample generating module 93 is specifically configured to, under the conditions that the ratio of the first reference box to the initial sample image is greater than or equal to a first preset threshold value, the pitch angle of the face is less than or equal to a first set value, the yaw angle of the face is less than or equal to a second set value, and the roll angle of the face is less than or equal to a third set value, move a specific coordinate point in the first reference box in accordance with a first set range, according to the position information of the first reference box, and obtain a second reference box.

Further, the sample generating module 93 is specifically configured to: determine an overlapping area between the second reference box and the first reference box, according to the position information of the second reference box and the position information of the first reference box; under the condition that a first ratio of the overlapping area to an area of the second reference box is greater than or equal to a third preset threshold value, generate a first preset range according to a first preset probability, generate a second preset range according to a second preset probability, generate a third preset range according to a third preset probability, and generate a fourth preset range according to a fourth preset probability; where the first preset probability is greater than the second preset probability, the second preset probability is greater than the third preset probability, and the third preset probability is greater than or equal to the fourth preset probability; and a sum of the first preset probability, the second preset probability, the third preset probability and the fourth preset probability is 1; when the first ratio is within the first preset range, determine and mark a partial sample image, which is a part of the initial sample image in the second reference box, with a first class label, such that a second ratio of the number of training images with the first ratio within the first preset range and marked with the first class label to the total number of all the training images marked with the first class label in the training data set is the first preset probability; when the first ratio is within the second preset range, determine and mark a partial sample image, which is a part of the initial sample image in the second reference box, with a first class label, such that a second ratio of the number of training images with the first ratio within the second preset range and marked with the first class label to the total number of all the training images marked with the first class label in the training data set is the second preset probability; when the first ratio is within the third preset range, determine and mark a partial sample image, which is a part of the initial sample image in the second reference box, with a first class label, such that a second ratio of the number of training images with the first ratio within the third preset range and marked with the first class label to the total number of all the training images marked with the first class label in the training data set is the third preset probability; when the first ratio is within the fourth preset range, determine and mark a partial sample image, which is a part of the initial sample image in the second reference box, with a first class label, such that a second ratio of the number of training images with the first ratio within the fourth preset range and marked with the first class label to the total number of all the training images marked with the first class label in the training data set is the fourth preset probability; where data in the first preset range are less than data in the second preset range, the data in the second preset range are less than data in the third preset range, and the data in the third preset range are less than data in the fourth preset rangege.

In some embodiments, the pose information includes at least pitch, yaw, and roll angles of the face; the sample generating module 93 is specifically configured to, under the conditions that the ratio of the first reference box to the initial sample image is greater than or equal to a first preset threshold value, the pitch angle of the face is greater than a first set value, the yaw angle of the face is greater than a second set value, and the roll angle of the face is greater than a third set value, move a specific coordinate point in the first reference box in accordance with a second set range, according to the position information of the first reference box, and obtain a second reference box.

Furthermore, the sample generating module 93 is specifically configured to: determine an overlapping area between the second reference box and the first reference box, according to the position information of the second reference box and the position information of the first reference box; under the condition that a third ratio of the overlapping area to an area of the second reference box is greater than or equal to a third preset threshold value, generate a first preset range according to the first preset probability, generate a second preset range according to the second preset probability, generate a third preset range according to the third preset probability, and generate a fourth preset range according to the fourth preset probability; where the first preset probability is greater than the second preset probability, the second preset probability is greater than the third preset probability, and the third preset probability is greater than or equal to the fourth preset probability; and a sum of the first preset probability, the second preset probability, the third preset probability and the fourth preset probability is 1; when the third ratio is within the first preset range, determine and mark a partial sample image, which is a part of the initial sample image in the second reference box, with a second class label, such that a fourth ratio of the number of training images with the third ratio within the first preset range and marked with the second class label to the total number of all the training images marked with the second class label in the training data set is the first preset probability; when the third ratio is within the second preset range, determine and mark a partial sample image, which is a part of the initial sample image in the second reference box, with a second class label, such that a fourth ratio of the number of training images with the third ratio within the second preset range and marked with the second class label to the total number of all the training images marked with the second class label in the training data set is the second preset probability; when the third ratio is within the third preset range, determine and mark a partial sample image, which is a part of the initial sample image in the second reference box, with a second class label, such that a fourth ratio of the number of training images with the third ratio within the third preset range and marked with the second class label to the total number of all the training images marked with the second class label in the training data set is the third preset probability; when the third ratio is within the fourth preset range, determine and mark a partial sample image, which is a part of the initial sample image in the second reference box, with a second class label, such that a fourth ratio of the number of training images with the third ratio within the fourth preset range and marked with the second class label to the total number of all the training images marked with the second class label in the training data set is the fourth preset probability; where data in the first preset range are less than data in the second preset range, the data in the second preset range are less than data in the third preset range, and the data in the third preset range are less than data in the fourth preset rangege.

In some embodiments, the pose information includes at least pitch, yaw, and roll angles of the face; and the sample generating module 93 is specifically configured to, when a ratio of the first reference box to the initial sample image is less than the first preset threshold value and greater than a second preset threshold value, move a specific coordinate point in the first reference box in accordance with a third set range, according to the position information of the first reference box, to obtain the second reference box; where the first preset threshold value is greater than the second preset threshold value.

Furthermore, the sample generating module 93 is specifically configured to: determine an overlapping area between the second reference box and the first reference box, according to the position information of the second reference box and the position information of the first reference box; under the condition that a fifth ratio of the overlapping area to an area of the second reference box is less than a third preset threshold value, generate a fifth preset range according to a fifth preset probability, generate a sixth preset range according to a sixth preset probability, and generate a seventh preset range according to a seventh preset probability; where the fifth preset probability is greater than the sixth preset probability, and the sixth preset probability is greater than the seventh preset probability; and a sum of the fifth preset probability, the sixth preset probability and the seventh preset probability is 1; when the fifth ratio is within the fifth preset range, determine and mark a partial sample image, which is a part of the initial sample image in the second reference box, with a third class label, such that a sixth ratio of the number of training images with the fifth ratio within the fifth preset range and marked with the third class label to the total number of all the training images marked with the third class label in the training data set is the fifth preset probability; when the fifth ratio is within the sixth preset range, determine and mark a partial sample image, which is a part of the initial sample image in the second reference box, with a third class label, such that a sixth ratio of the number of training images with the sixth ratio within the sixth preset range and marked with the third class label to the total number of all the training images marked with the third class label in the training data set is the sixth preset probability; when the fifth ratio is within the seventh preset range, determine and mark a partial sample image, which is a part of the initial sample image in the second reference box, with a third class label, such that a sixth ratio of the number of training images with the sixth ratio within the seventh preset range and marked with the third class label to the total number of all the training images marked with the third class label in the training data set seventh preset probability; where data in the seventh preset range is less than data in the sixth preset range, and the data in the sixth preset range is less than data in the fifth preset range.

In some embodiments, under the condition that the face recognition performed on the initial sample image determines that no face exists, the initial sample image is marked with a fourth class label, and the initial sample image marked with the fourth class label is used as a training image.

In some embodiments, the sample labels further include a fourth class label for representing non-gaze; the sample generating module 93 is further configured to determine a target central point in the initial sample image in accordance with a fourth set range, according to a size of the initial sample image, and determine a third reference box with the target central point as a center; if the third reference box is not overlapped with any first reference box in the initial sample image, mark a partial sample image, which is a part of the initial sample image in the third reference box, with a fourth class label, and take the partial sample image marked with the fourth class label as a training image.

In addition, an embodiment of the present disclosure further provides a control apparatus of a broadcast monitoring system corresponding to the control method of a broadcast monitoring system in the second aspect. Since a principle of solving the problem of the control apparatus of a broadcast monitoring system in the embodiment of the present disclosure is similar to that of the control method of a broadcast monitoring system in the above second aspect in the embodiment of the present disclosure, implementation of the control apparatus of a broadcast monitoring system may refer to the implementation of the corresponding control method in the second aspect, and repeated description is omitted.

FIG. 10 is a schematic diagram illustrating a control apparatus of a broadcast monitoring system according to an embodiment of the present disclosure, and as shown in FIG. 10, the control apparatus includes a detection apparatus 101 and a terminal 102. The detection apparatus 101 may be, for example, an IMC chip integrated with Flash or SRAM.

The detection apparatus 101 is configured to acquire a detected image, and perform gaze recognition on the detected image through a pre-trained target neural network model, to obtain a recognition result of the detected image; and send the recognition result to the terminal.

The terminal 102 is configured to determine a display state based on the recognition result.

In some embodiments, the terminal 102 includes a display module 1022 and a main control module 1021. The main control module 1021 is configured to send an awakening request to the display module, under the condition that the recognition result indicates that an object gazes; send a sleep request to the display module under the condition that the recognition result indicates that no object gazes and it is longer than a preset duration from the latest awakening time of the display module to the current system time. The display module 1022 is configured to determine that the display state is normal display, in response to the awakening request; and determine that the display state is sleep, in response to the sleep request.

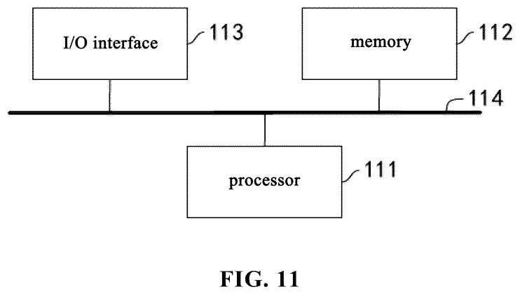

FIG. 11 is a schematic diagram illustrating a computer device according to an embodiment of the present disclosure. As shown in FIG. 11, the computer device according to the embodiment of the present disclosure includes one or more processors 111, a memory 112, and one or more I/O interfaces 113. The memory 112 stores thereon one or more programs which, when executed by the one or more processors, cause the one or more processors to implement the control method of a broadcast monitoring system in any one of the above embodiments. The one or more I/O interfaces 113 are coupled between the one or more processors and the memory, and are configured to enable information interaction between the one or more processors and the memory.

The processor 111 is a device with data processing capability, which includes but is not limited to a central processing unit (CPU), or the like. The memory 112 is a device having data storage capabilities including, but not limited to, random access memory (RAM, more specifically SDRAM, DDR, etc.), read only memory (ROM), electrically erasable programmable read only memory (EEPROM), flash memory (FLASH). The I/O interface (read/write interface) 113 coupled between the processor 111 and the memory 112 may enable information interaction between the processor 111 and the memory 112, which may include, but is not limited to, a data bus (Bus), or the like.

In some embodiments, the processor 111, the memory 112, and the I/O interface 113 are connected to each other through a bus 114, and in turn to other components of the computing device.

An embodiment of the present disclosure further provides a non-transitory computer readable storage medium. The non-transitory computer readable storage medium stores thereon a computer program which, when being executed by a processor, implements steps in any one control method of a broadcast monitoring system in the above embodiments.

In particular, according to an embodiment of the present disclosure, the procedure described above with reference to the flowchart may be implemented as a computer software program. For example, an embodiment of the present disclosure includes a computer program product including a computer program carried on a machine readable medium, where the computer program includes program codes for performing the method illustrated by the flowchart. In such an embodiment, the computer program may be downloaded and installed from a network via a communication part, and/or installed from a removable medium. The above functions defined in the system of the present disclosure are performed when the computer program is performed by a Central Processing Unit (CPU).

It should be noted that the non-transitory computer readable medium shown in the present disclosure may be a computer readable signal medium, a computer readable storage medium, or any combination of the two. A computer readable storage medium may be, for example, but not limited to, an electronic, magnetic, optical, electromagnetic, infrared, or semiconductor system, apparatus, or device, or any combination thereof. More specific examples of the computer readable storage medium may include, but are not limited to, an electrical connector having one or more wires, a portable computer diskette, a hard disk, a Random Access Memory (RAM), a Read-Only Memory (ROM), an Erasable Programmable Read-Only Memory (EPROM or flash memory), an optical fiber, a portable Compact Disc Read-Only Memory (CD-ROM), an optical storage device, a magnetic storage device, or any suitable combination thereof. In the present disclosure, a computer readable storage medium may be any tangible medium that contains or stores a program, which can be used by or in connection with an instruction execution system, apparatus, or device. In contrast, in the present disclosure, a computer readable signal medium may include a propagated data signal with computer readable program code carried therein, in a baseband or as a part of a carrier wave. Such a propagated data signal may take any of a variety of forms, including, but not limited to, electro-magnetic signal, optical signal, or any suitable combination thereof. A computer readable signal medium may alternatively be any non-transitory computer readable storage medium other than a computer readable storage medium, which may transmit, propagate, or convey a program for use by or in connection with an instruction execution system, apparatus, or device. The program codes on the non-transitory computer readable storage medium may be conveyed by any appropriate medium, including but not limited to a wireless medium, a wire, a fiber optic cable, RF, etc., or any suitable combination thereof.

The flowchart and block diagram in the figures illustrate an architecture, functionality, and operation possibly implemented by the apparatus, the method and the computer program product according to various embodiments of the present disclosure. In this regard, each block in the flowchart or block diagram may represent a module, a program segment, or a part of codes, which includes one or more executable instructions for implementing a specified logical function. It should also be noted that, in some alternative implementations, the function noted in the block may occur in a different order from that noted in the figures. For example, two blocks connected to each other may, in fact, denote to be executed substantially concurrently, or the blocks may sometimes be executed in a reverse order, depending upon the functionality involved. It should also be noted that each block in the block diagram and/or the flowchart, and combinations of blocks in the block diagram and/or the flowchart, may be implemented by a special purpose hardware-based system that performs the specified function or act, or by a combination of a special purpose hardware and computer instructions.

It will be understood that the above embodiments are merely exemplary embodiments adopted to illustrate the principles of the present disclosure, and the present disclosure is not limited thereto. It will be apparent to one of ordinary skill in the art that various modifications and improvements can be made without departing from the spirit and essence of the present disclosure, and such modifications and improvements are also considered to be within the scope of the present disclosure.

1. A control method of a broadcast monitoring system, comprising:
acquiring a detected image;
performing gaze recognition on the detected image through a target neural network model which is trained in advance, to obtain a recognition result of the detected image; and
sending the recognition result to a terminal, so that the terminal determines a display state based on at least the recognition result.

2. The control method of a broadcast monitoring system according to claim 1, wherein the target neural network model is trained by the following steps:
training a to-be-trained teacher network learning model according to an acquired training data set, to obtain a trained teacher network learning model; and
training a to-be-trained student network learning model by a knowledge distillation training method, according to the training data set and the trained teacher network learning model, to obtain a trained student network learning model as the target neural network model.

3. The control method of a broadcast monitoring system according to claim 2, wherein the training data set comprises a plurality of training images labeled with sample labels;
the training a to-be-trained student network learning model by a knowledge distillation training method, according to the training data set and the trained teacher network learning model, to obtain a trained student network learning model as the target neural network model, comprises:
inputting a training image of the plurality of training images into the trained teacher network learning model, to obtain a first output result of the trained teacher network learning model;
inputting the training image into the to-be-trained student network learning model, to obtain a second output result of the to-be-trained student network learning model;
determining a first loss function, according to the first output result and the second output result;
determining a second loss function, according to the second output result and a sample label of the training image;
obtaining a weighted loss function, according to the first loss function and the second loss function; and
adjusting parameters of the to-be-trained student network learning model according to the weighted loss function, until the weighted loss function is converged, to obtain the trained student network learning model as the target neural network model.

4. The control method of a broadcast monitoring system according to claim 3, wherein the training data set is determined through the following steps:
acquiring an original data set, wherein the original data set comprises a plurality of initial sample images;
performing face recognition on the initial sample image, if a face exists, determining a first reference box containing the face, and determining key point information of the face;
determining pose information of the face, according to the key point information;
updating the first reference box, according to the pose information and a ratio of the first reference box to the initial sample image, to obtain a second reference box; and
marking a partial sample image, which is a part of the initial sample image in the second reference box, with a sample label, according to the first reference box and the second reference box, and taking the partial sample image marked with the sample label as a training image,
wherein the sample labels comprise a first class label for representing gaze, and a second class label and a third class label for representing non-gaze;
the first class label indicates that a pitch angle of the face is less than or equal to a first set value, a yaw angle of the face is less than or equal to a second set value, or a roll angle of the face is less than or equal to a third set value, when a ratio of the second reference box in the training image to the training image is greater than or equal to a first preset threshold value;
the second class label indicates that the pitch angle of the face is greater than the first set value, the yaw angle of the face is greater than the second set value, or the roll angle of the face is greater than the third set value, when the ratio of the second reference box in the training image to the training image is greater than or equal to the first preset threshold value; and
the third class label represents that the ratio of the second reference box in the training image to the training image is less than the first preset threshold value and greater than a second preset threshold value.

5. The control method of a broadcast monitoring system according to claim 4, wherein the pose information comprises at least the pitch angle, the yaw angle and the roll angle of the face; and
the updating the first reference box, according to the pose information and a ratio of the first reference box to the initial sample image, to obtain a second reference box, comprises:
moving a specific coordinate point in the first reference box in accordance with a first set range, according to position information of the first reference box, to obtain the second reference box, under the conditions that the ratio of the first reference box to the initial sample image is greater than or equal to the first preset threshold value, the pitch angle of the face is less than or equal to the first set value, the yaw angle of the face is less than or equal to the second set value, and the roll angle of the face is less than or equal to the third set value.

6. The control method of a broadcast monitoring system according to claim 5, wherein the marking a partial sample image, which is a part of the initial sample image in the second reference box, with a sample label, according to the first reference box and the second reference box, and taking the partial sample image marked with the sample label as a training image, comprises:
determining an overlapping area between the second reference box and the first reference box, according to position information of the second reference box and the position information of the first reference box;
generating a first preset range according to a first preset probability, generating a second preset range according to a second preset probability, generating a third preset range according to a third preset probability, and generating a fourth preset range according to a fourth preset probability, under the condition that a first ratio of the overlapping area to an area of the second reference box is greater than or equal to a third preset threshold value; wherein the first preset probability is greater than the second preset probability, the second preset probability is greater than the third preset probability, and the third preset probability is greater than or equal to the fourth preset probability; and a sum of the first preset probability, the second preset probability, the third preset probability and the fourth preset probability is 1;
when the first ratio is within the first preset range, determining and marking the partial sample image of the initial sample image in the second reference box, with the first class label, such that a second ratio of a number of training images with the first ratio within the first preset range and marked with the first class label to a total number of all the training images marked with the first class label in the training data set is the first preset probability;
when the first ratio is within the second preset range, determining and marking the partial sample image of the initial sample image in the second reference box, with the first class label, such that a second ratio of a number of training images with the first ratio within the second preset range and marked with the first class label to a total number of all the training images marked with the first class label in the training data set is the second preset probability;
when the first ratio is within the third preset range, determining and marking the partial sample image of the initial sample image in the second reference box, with the first class label, such that a second ratio of a number of training images with the first ratio within the third preset range and marked with the first class label to a total number of all the training images marked with the first class label in the training data set is the third preset probability; and
when the first ratio is within the fourth preset range, determining and marking the partial sample image of the initial sample image in the second reference box, with the first class label, such that a second ratio of a number of training images with the first ratio within the fourth preset range and marked with the first class label to a total number of all the training images marked with the first class label in the training data set is the fourth preset probability;
wherein data in the first preset range are less than data in the second preset range, the data in the second preset range are less than data in the third preset range, and the data in the third preset range are less than data in the fourth preset range.

7. The control method of a broadcast monitoring system according to claim 4, wherein the pose information comprises at least the pitch angle, the yaw angle and the roll angle of the face; and
the updating the first reference box, according to the pose information and a ratio of the first reference box to the initial sample image, to obtain a second reference box, comprises:
moving a specific coordinate point in the first reference box in accordance with a second set range, according to position information of the first reference box, to obtain the second reference box, under the conditions that the ratio of the first reference box to the initial sample image is greater than or equal to the first preset threshold value, the pitch angle of the face is greater than the first set value, the yaw angle of the face is greater than the second set value, and the roll angle of the face is greater than the third set value.

8. The control method of a broadcast monitoring system according to claim 7, wherein the marking a partial sample image, which is a part of the initial sample image in the second reference box, with a sample label, according to the first reference box and the second reference box, and taking the partial sample image marked with the sample label as a training image, comprises:
determining an overlapping area between the second reference box and the first reference box, according to position information of the second reference box and the position information of the first reference box;
generating a first preset range according to a first preset probability, generating a second preset range according to a second preset probability, generating a third preset range according to the third preset probability, and generating a fourth preset range according to a fourth preset probability, under the condition that a third ratio of the overlapping area to an area of the second reference box is greater than or equal to a third preset threshold value; wherein the first preset probability is greater than the second preset probability, the second preset probability is greater than the third preset probability, and the third preset probability is greater than or equal to the fourth preset probability; and a sum of the first preset probability, the second preset probability, the third preset probability and the fourth preset probability is 1;
when the third ratio is within the first preset range, determining and marking the partial sample image of the initial sample image in the second reference box, with the second class label, such that a fourth ratio of a number of training images with the third ratio within the first preset range and marked with the second class label to a total number of all the training images marked with the second class label in the training data set is the first preset probability;
when the third ratio is within the second preset range, determining and marking the partial sample image of the initial sample image in the second reference box, with the second class label, such that a fourth ratio of a number of training images with the third ratio within the second preset range and marked with the second class label to a total number of all the training images marked with the second class label in the training data set is the second preset probability;
when the third ratio is within the third preset range, determining and marking the partial sample image of the initial sample image in the second reference box, with the second class label, such that a fourth ratio of a number of training images with the third ratio within the third preset range and marked with the second class label to a total number of all the training images marked with the second class label in the training data set is the third preset probability; and
when the third ratio is within the fourth preset range, determining and marking the partial sample image of the initial sample image in the second reference box, with the second class label, such that a fourth ratio of a number of training images with the third ratio within the fourth preset range and marked with the second class label to a total number of all the training images marked with the second class label in the training data set is the fourth preset probability;
wherein data in the first preset range are less than data in the second preset range, the data in the second preset range are less than data in the third preset range, and the data in the third preset range are less than data in the fourth preset range.

9. The control method of a broadcast monitoring system according to claim 4, wherein the pose information comprises at least the pitch angle, the yaw angle and the roll angle of the face;
the updating the first reference box, according to the pose information and a ratio of the first reference box to the initial sample image, to obtain a second reference box, comprises:
moving a specific coordinate point in the first reference box in accordance with a third set range, according to position information of the first reference box, to obtain the second reference box, under the condition that the ratio of the first reference box to the initial sample image is less than the first preset threshold value and greater than the second preset threshold value; wherein the first preset threshold value is greater than the second preset threshold value.

10. The method of controlling a broadcast monitoring system according to claim 9, wherein the marking a partial sample image, which is a part of the initial sample image in the second reference box, with a sample label, according to the first reference box and the second reference box, and taking the partial sample image marked with the sample label as a training image, comprises:
determining an overlapping area between the second reference box and the first reference box, according to position information of the second reference box and the position information of the first reference box;
generating a fifth preset range according to a fifth preset probability, generating a sixth preset range according to a sixth preset probability, and generating a seventh preset range according to a seventh preset probability, under the condition that a fifth ratio of the overlapping area to an area of the second reference box is less than a third preset threshold value; wherein the fifth preset probability is greater than the sixth preset probability, and the sixth preset probability is greater than the seventh preset probability; and a sum of the fifth preset probability, the sixth preset probability and the seventh preset probability is 1;
when the fifth ratio is within the fifth preset range, determining and marking the partial sample image of the initial sample image in the second reference box, with the third class label, such that a sixth ratio of a number of training images with the third ratio within the fifth preset range and marked with the third class label to a total number of all the training images marked with the third class label in the training data set is the fifth preset probability;
when the fifth ratio is within the sixth preset range, determining and marking the partial sample image of the initial sample image in the second reference box, with the third class label, such that a sixth ratio of a number of training images with the fifth ratio within the sixth preset range and marked with the third class label to a total number of all the training images marked with the third class label in the training data set is the sixth preset probability; and
when the fifth ratio is within the seventh preset range, determining and marking the partial sample image of the initial sample image in the second reference box, with the third class label, such that a sixth ratio of a number of training images with the fifth ratio within the seventh preset range and marked with the third class label to a total number of all the training images marked with the third class label in the training data set is the seventh preset probability;
wherein data in the seventh preset range is less than data in the sixth preset range, and the data in the sixth preset range is less than data in the fifth preset range.

11. The control method of a broadcast monitoring system according to claim 4, wherein the sample labels further comprise a fourth class label for representing non-gaze;
when the training data set is determined, under the condition that the face recognition performed on the initial sample image determines that no face exists, the method further comprises:
marking the initial sample image with a fourth class label, and taking the initial sample image marked with the fourth class label as a training image.

12. The control method of a broadcast monitoring system according to claim 4, wherein the sample labels further comprise a fourth class label for representing non-gaze; and
after the performing face recognition on the initial sample image, if a face exists, determining a first reference box containing the face, the method further comprises:
determining a target central point in the initial sample image in accordance with a fourth set range, according to a size of the initial sample image, and determining a third reference box with the target central point as a center; and
if the third reference box is not overlapped with any first reference box in the initial sample image, marking a partial sample image, which is a part of the initial sample image in the third reference box, with a fourth class label, and taking the partial sample image marked with the fourth class label as a training image.

13. A control method of a broadcast monitoring system, wherein the broadcast monitoring system comprises a detection apparatus and a terminal; and the control method comprises:
by the detection apparatus, acquiring a detected image, and performing gaze recognition on the detected image through a pre-trained target neural network model, to obtain a recognition result of the detected image; and sending the recognition result to the terminal; and
determining, by the terminal, a display state based on the recognition result.

14. The control method of a broadcast monitoring system according to claim 13, wherein the terminal comprises a display module and a main control module; and
the determining, by the terminal, a display state based on the recognition result, comprises:
sending, by the main control module, an awakening request to the display module under the condition that the recognition result indicates that an object gazes; sending, by the main control module, a sleep request to the display module under the conditions that the recognition result indicates that no object gazes and it is longer than a preset duration from the latest awakening time of the display module to the current system time; and
determining, by the display module, that the display state is normal display, in response to the awakening request; and determining, by the display module, that the display state is sleep, in response to the sleep request.

15. A detection apparatus configured to acquire a detected image, and perform gaze recognition on the detected image through a pre-trained target neural network model, to obtain a recognition result of the detected image; and send the recognition result to a terminal, so that the terminal determines a display state based on at least the recognition result.

16. A control apparatus of a broadcast monitoring system, comprising detection apparatus according to claim 15 and a terminal;
wherein
the terminal is configured to determine a display state based on the recognition result.

17. A computer device, comprising a processor, a memory and a bus, wherein the memory stores machine-readable instructions executable by the processor, the processor and the memory communicate with each other through the bus, when the computer device is running, and the machine-readable instructions, when executed by the processor, cause the processor to perform steps of the control method of a broadcast monitoring system according to claim 1.

18. A non-transitory computer readable storage medium storing thereon a computer program which, when being executed by a processor, performs steps of the control method of a broadcast monitoring system according to claim 1.

19. A computer device, comprising a processor, a memory and a bus, wherein the memory stores machine-readable instructions executable by the processor, the processor and the memory communicate with each other through the bus, when the computer device is running, and the machine-readable instructions, when executed by the processor, cause the processor to perform steps of the control method of a broadcast monitoring system according to claim 13.

20. A non-transitory computer readable storage medium storing thereon a computer program which, when being executed by a processor, performs steps of the control method of a broadcast monitoring system according to claim 13.
